(19) United States
(12) Patent Application Publication
(10) Pub. No.: US 2026/0032268 A1
(43) Pub. Date: Jan. 29, 2026

(54) VIDEO ENCODING AND DECODING

(71) Applicant: BLACKBIRD PLC, London (GB)

(72) Inventor: Stephen STREATER, London (GB)

(21) Appl. No.: 18/997,039

(22) PCT Filed: Jul. 24, 2023
(86) PCT No.: PCT/GB2023/051945

§ 371 Date: Jan. 18, 2025

(30) Foreign Application Priority Data
Jul. 22, 2022 (GB) 2210773.4
Nov. 4, 2022 (GB) 2216478.4

(51) Int. Cl. H04N 19/186; H04N 19/14; H04N 19/196

(52) U.S. Cl. CPC H04N 19/186; H04N 19/14; H04N 19/198

(57) ABSTRACT

A computer-implemented method of encoding a colour video comprising colour video frames including 1920 pixels by 1080 pixels, comprising: encoding colour video frames using a 240 elements by 135 elements representation of the 1920 pixels by 1080 pixels, each element comprising an encoded 8×8 pixel block, each encoded 8×8 pixel block being represented using a codeword 64 bits. A related computer-implemented method includes decoding to generate a colour video. Related devices and computer program products are disclosed.

### BACKGROUND OF THE INVENTION

### 1. Field of the Invention

The field of the invention relates to computer-implemented methods of encoding a colour video, the colour video comprising colour video frames; to computer-implemented methods of decoding to generate a colour video, the colour video comprising colour video frames; to related devices, and to related computer program products.

### 2. Technical Background

Video is increasingly dominating the Internet. The majority of internet content, both on fixed line and on mobile, is now video content.

It may be desired to provide a new video codec that will run for 1080p class images, the resolution being 1920×1080, with about 2.1 megapixels, and a screen aspect ratio of 16:9. The images should typically be displayed using Javascript, at 60 fps (frames per second), at 30 bpp (bits per pixel) colour depth, which is e.g. 10 bits each for red, green and blue. 2.1 megapixels at 60 fps is about 120 million pixels per second. One may run in javascript which can process about 1 billion instructions per second on a 5 GHz CPU.

This new video codec may or must provide rendering, e.g. real-time rendering. A video player may download the data to a download cache. The downloaded data in the cache has to be decompressed, and this decompression would have to be performed prior to display, because there is a great deal of data to be processed.

The amount of data per frame is 1920×1080×4, which is about 8 MB (megabytes), where the ‘4’ bytes derives from 30 bpp colour depth. At 60 fps, this is about 480 MB per second, or about ½ a gigabyte (GB) per group of 64 frames, where 64 frames can be the number of frames from one key frame to the next key frame. We tend to store frames in groups or chunks of 64 frames, hence this is a relevant calculation of memory size for us.

It would be challenging to provide encoded video that is suitable for decoding from an internet stream to provide real-time display on a typical consumer device (e.g. smartphone, tablet computer, laptop, desktop computer) for 1080p class images, for example using a browser.

### 3. Discussion of Related Art

Regarding technical disclosures in relation to video files and video file editing, reference may be had to EP1738365B1, WO2005101408A1, U.S. Pat. No. 8,255,802B2, WO2005048607A1, U.S. Pat. No. 9,179,143B2, U.S. Pat. No. 8,711,944B2, WO2007077447A2, U.S. Pat. No. 8,660,181B2, EP3329678 (B1), U.S. Pat. No. 11,057,657B2, U.S. Pat. No. 11,082,699B2, and to U.S. Pat. No. 11,582,497B2, which are incorporated by reference.

### SUMMARY OF THE INVENTION

According to a first aspect of the invention, there is provided a computer-implemented method of encoding a colour video, the colour video comprising colour video frames, the colour video frames including 1920 pixels by 1080 pixels, the method including the step of:

(i) encoding colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits.

An advantage is that the encoded colour video can be decoded and displayed, in real-time, on a display including 1920 pixels by 1080 pixels, of a common computer device such as a smartphone, a tablet computer, a laptop computer or a desktop computer, e.g. in a browser, executing javascript code. An advantage is that the encoded colour video requires less energy to transmit than alternative compression schemes producing similar display quality when decompressed, which saves energy, which is environmentally beneficial.

The method may be one wherein encoding the video includes lossy encoding. The method may be one wherein encoding the video does not use a Fourier transform. An advantage is a reduced chance of a colouring artefact.

The method may be one wherein in the codeword colour is represented using at least ten bits each for YUV.

The method may be one wherein in the codeword colour is represented using at least ten bits each for RGB.

The method may be one wherein the codeword comprises 64 bits including a codeword type, with zero or more extension codewords depending on the codeword type specified.

The method may be one wherein each 64 bit codeword representing its block has its own type and list of zero or more extensions.

The method may be one wherein the codeword includes 64 bits, comprising a flag including at least 4 bits, data bits e.g. 30 bits of data, and 30 bits to represent ten bits each for the Y value, the U value and the V value, or ten bits each for the R value, the G value and the B value.

The method may be one wherein the codeword consists of exactly 64 bits. An advantage is that this codeword size is processed efficiently by processors.

The method may be one wherein one or more bits in the (e.g. 30) data bits is used as an extension pointer, which points to extension block(s) which include extra data, for use with specific flag values, in which the specific flag values correspond to encoded 8×8 pixel blocks including image data that is too complex to represent accurately in a standard 64 bit codeword. An advantage is that more complex 8×8 pixel blocks can be encoded.

The method may be one wherein some encoded 8×8 pixel blocks are represented using a representation including a codeword, the codeword including 64 bits, the representation further including an extension block, e.g. including 64 bits. An advantage is that more complex 8×8 pixel blocks can be encoded.

The method may be one wherein the extension block consists of exactly 64 bits. An advantage is that this extension block size is processed efficiently by processors. The method may be one wherein a codeword unique flag value corresponds to a uniform block, with a colour given by 30 bits that represent colour.

The method may be one in which the data part of the uniform block codeword is all zeros, or all ones, because there is no data.

The method may be one wherein a codeword unique flag value corresponds to a bilinear interpolation, in which four colour values are used to perform a bilinear interpolation, the four colour values including one colour for each corner, in which one colour value for one corner is represented in the codeword, and the other three colours are obtained from the codewords for blocks neighbouring the other three corners. An advantage is that these block types are processed efficiently by a processor.

The method may be one in which the data part of the bilinearly interpolated block codeword is all zeros, or all ones, because there is no data.

The method may be one in which the bilinear interpolation is performed moving in a direction by adding a first constant value, and the bilinear interpolation is performed moving orthogonal to the direction by adding a second constant value.

The method may be one in which a bilinearly interpolated encoded 8×8 pixel block is defined using dithering. An advantage is that this is processed faster than performing bilinear interpolation calculations.

The method may be one wherein a codeword unique flag value corresponds to an encoded 8×8 pixel block including a single edge, the single edge position defined by 9 or 10 bits in the data bits. An advantage is that these block types are processed efficiently by a processor.

The method may be one wherein for each pixel, a dither value is stored using three bits. An advantage is efficient storage of dither values.

The method may be one wherein to determine the colour at a corner of a 8×8 pixel block, in a region where there are no abrupt changes in colour, e.g. there are no edges, the colour is determined by averaging the colours in an (e.g. 8×8) pixel area centred on the corner. An advantage is that corner colours are efficiently stored.

The method may be one wherein to determine the colour at a corner of a pixel block, for part of an edge-containing image of an 8×8 pixel block, the part containing only one corner, the selected colour is chosen by averaging pixels including using some pixels in neighbouring 8×8 pixel blocks. An advantage is a choice of corner colour, with a low chance of a colouring artefact.

The method may be one in which to make the averaging unbiased, an area of pixels outside the 8×8 pixel block is excluded from the averaging process which is symmetric, relative to the one corner, with the area of pixels in the 8×8 pixel block which is on the opposite side of the edge to the one corner. An advantage is a choice of corner colour, with a low chance of a colouring artefact.

The method may be one wherein to evaluate a corner colour when an edge passes directly through the corner, the colour C1 for the corner through which the edge passes is evaluated using the colours of the other three corners C2, C3 and C4 though which the edge does not pass, e.g. by averaging C2, C3 and C4, or by using bilinear extrapolation of the colours C2, C3, C4. An advantage is a choice of corner colour, with a low chance of a colouring artefact.

The method may be one wherein in the case of a 8×8 pixel block including an edge and a corner on one side of the edge, a block corner colour is selected for the corner using only use pixel colours which are on the same side of the edge as the corner. An advantage is a choice of corner colour, with a low chance of a colouring artefact. The method may be one wherein an edge type identifier is stored for a 8×8 pixel block in which an edge passes directly through a corner.

The method may be one in which the edge types do not exceed 512, and hence are represented using 9 bits. An advantage is pixel block colouring, with a low chance of a colouring artefact.

The method may be one in which a fake corner colour is stored using one bit of three bits of a dither value. An advantage is pixel block colouring, with a low chance of a colouring artefact.

The method may be one in which fake colour C1′=C2+C3-C4, in which the pixel block corner colours are C1, C2, C3 and C4. An advantage is pixel block colouring, with a low chance of a colouring artefact.

The method may be one in which if an out-of range fake colour C1′ results from using C1′=C2+C3-C4, in which the pixel block corner colours are C1, C2, C3 and C4, the values of C2, C3 and C4 are adjusted and stored, such that an out-of range fake colour does not result from using C1′=C2+C3-C4. An advantage is pixel block colouring, with a low chance of a colouring artefact.

The method may be one in which the encoder only outputs cases in which there is no out of range problem for fake colour C1′, and hence a different representation to the single edge representation of the 8×8 pixel block is used if there is an out-of-range problem for C1′. An advantage is pixel block colouring, with a low chance of a colouring artefact.

The method may be one in which dither values for each pixel as a function of edge position, for all possible edge positions, are stored in lookup tables. An advantage is faster and improved pixel block colouring.

The method may be one in which edges include soft edges, or edges include hard edges, or edges include soft edges and hard edges.

The method may be one in which in the case of a soft edge, for an 8×8 pixel block which is coloured-in using dithering using a lookup table, some pixels in the part of the 8×8 pixel block for the corner closest to the edge are coloured in using not the colour of the corner closest to the edge, but using colours from the other corners. An advantage is faster and improved pixel block colouring.

The method may be one including storing a lookup table which determines which of the four corner colours to insert for a given pixel in an 8×8 pixel block. An advantage is faster and improved pixel block colouring.

The method may be one wherein the stored lookup tables require 12 to 16 kbytes of memory. An advatange is that this can be used to speed-up processing, because it fits in a L1 cache.

The method may be one wherein stored dither lookup tables include lookup tables for soft edges.

The method may be one wherein stored dither lookup tables include lookup tables for hard edges.

The method may be one wherein a codeword unique flag value corresponds to an 8×8 block including two edges comprising a first edge and a second edge, in which the second edge is placed on top of the first edge. An advantage is faster and improved pixel block colouring.

The method may be one wherein the first edge and the second edge are at any angle to each other which is permitted by 8×8 pixel block geometry.

The method may be one wherein a codeword unique flag value corresponds to an 8×8 pixel block including one line. An advantage is faster and improved pixel block colouring.

The method may be one wherein either side of the line, the pixels are bilinearly interpolated.

The method may be one wherein the pixels are bilinearly interpolated using the colour values of the four corners.

The method may be one wherein the 8×8 pixel block is one in which the line has a line colour, and either side of the line the same or a similar non-line colour is encoded. The method may be one in which when an edge or a line continues from one 8×8 pixel block to the next 8×8 pixel block, there is only stored one end of the line or edge with respect to an individual 8×8 pixel block, as the next point on the line or edge is defined with respect to the adjacent 8×8 pixel block including the next point on the line or edge. An advantage is faster and improved pixel block colouring.

The method may be one wherein a codeword unique flag value corresponds to an 8×8 block including texturing two YUV values, or to texturing two RGB values; the 30 bit data contains the offset to the YUV or RGB value encoded in the colour 30 bits of the 64 bit codeword. An advantage is faster and improved pixel block colouring. The method may be one wherein a contrast is encoded in extra data (e.g. +/−8 grey scales), and an offset to the mask is encoded in extra data, in which case data additional to the 64 bit codeword is used, in an extension block, to store the additional data.

The method may be one wherein the two YUV or RGB values are determined from the original 8×8 pixel block data as follows: for the Y value, the highest and lowest values are found, and then the Y values that are 25% and 75% of the difference between the lowest and highest values are determined, starting from the lowest value; repeating this process for the U values, and the V values; the two YUV values for the two textures are then defined by the YUV values that are 25% of the difference between the minimum and maximum YUV values, starting from the minimum YUV values, and that are 75% of the difference between the minimum and maximum YUV values, starting from the minimum YUV values; this is performed in a similar way for RGB values. An advantage is faster and improved pixel block colouring.

The method may be one wherein which of the two textures to use in each pixel of the 8×8 pixel block is encoded with a ‘l’ or a zero for each pixel, hence using 8×8-64 bits. An advantage is faster and improved pixel block colouring.

The method may be one wherein a codeword unique flag value corresponds to an 8×8 block including texturing three YUV or RGB values; the main colour value is the YUV or RGB value encoded in the 30 colour bits of the codeword; then there is a plus offset to the YUV or RGB value, that is encoded in 30 bits, and a minus offset to the YUV or RGB value that is encoded in 30 bits; in this case, the codeword plus extension block(s) is at least 128 bits long, so it can include all the required data. An advantage is faster and improved pixel block colouring.

The method may be one in which two bits are used to represent which of the three textures corresponds to each pixel of the 8×8 pixel block, so this is encoded using two bits for each pixel, hence using 8×8×2=128 bits.

The method may be one in which the three YUV or RGB values are determined from the original 8×8 pixel block data as follows: for the Y value, find its highest and lowest values, and then determine the Y values that are 25%, 50% and 75% of the difference between the lowest and highest values, starting from the lowest value;

repeat this process for the U values, and the V values; the three YUV values for the three textures are then defined by the YUV values that are 25% of the difference between the minimum and maximum YUV values, starting from the minimum YUV values, that are 50% of the difference between the minimum and maximum YUV values, starting from the minimum YUV values, and that are 75% of the difference between the minimum and maximum YUV values, starting from the minimum YUV values, respectively; this is performed in a similar way for RGB values. An advantage is faster and improved pixel block colouring.

The method may be one wherein a codeword unique flag value corresponds to an 8×8 pixel block including no compression.

The method may be one wherein a codeword unique flag value corresponds to an 8×8 block for representing an e.g. irregular, shape, the codeword including a 64 bit mask (a “Y mask”) which stores if the Y values should be increased (plus) or decreased (minus) relative to the average Y value of the 8×8 pixel block; there is stored the increase in the Y value, where the Y value is increased; there are stored, in e.g. 20 bits, the UV value (e.g. 10 bits each for U and V), for use when the Y value is increased, and there are stored, e.g. in a further 20 bits, the UV value (10 bits each for U and V) for use when the Y value is decreased, e.g. leading to a total of 40 bits for the increased Y's UV value and for the decreased Y's UV value. An advantage is faster and improved pixel block colouring.

The method may be one wherein the negative of the stored increase in the Y value, is used to decrease the Y value, where the Y value is decreased.

The method may be one wherein there is stored a decrease in the Y value, which is used to decrease the Y value, where the Y value is decreased.

The method may be one in which the Y mask, the UV value for use when the Y value is decreased, and the UV value for use when the Y value is decreased, are compressed. The method may be one in which the Y mask, the UV value for use when the Y value is decreased, and the UV value for use when the Y value is decreased, are compressed losslessly. An advantage is pixel block colouring, with a low chance of a colouring artefact.

The method may be one in which the Y mask is compressed using run-length encoding, in a snake path across the 8×8 pixel block. An advantage is faster and improved pixel block colouring.

The method may be one in which the snake path is a horizontal snake path. The method may be one in which the snake path is a vertical snake path.

The method may be one in which the run-length encoding encodes the length using three bits, including 000 to 110 denoting a sequence of up to six of the same sign, with 111 denoting that the sequence is too long to be encoded in the three bits and carries on such that the next three bit value needs to be followed. An advantage is pixel block colouring, with a low chance of a colouring artefact.

The method may be one in which for the first entry, decimal zero to six are used to represent a sequence of one to seven of the same sign. An advantage is pixel block colouring, with a low chance of a colouring artefact.

The method may be one in which at the end of the data for the Y mask, if there is a single final pixel which has not been specified, it is assumed that the sign changes for the single final pixel, and that the UV value is that for the 8×8 pixel block. An advantage is faster pixel block colouring.

The method may be one in which header bits are used, which encode whether the first pixel is a plus or a minus, and whether the snake path is horizontal or vertical, and a UV differ flag. An advantage is faster and improved pixel block colouring.

The method may be one in which the UV differ flag indicates whether or not the increased Y's UV value and the decreased Y's UV value are the same.

The method may be one in which if the UV values are not the same, then the compressed structure stores the range of UV values, relative to the UV value of the 8×8 pixel block, wherein the representation of the compression of the UV values must fit in the available number of bits in the data structure after the Y mask values have been encoded. An advantage is faster and improved pixel block colouring.

The method may be one in which if the UV range is from −1 to 0, or from 0 to +1, this is stored using a first bit to distinguish between these two possibilities, and there are four times one bit, about whether the change applies to each U and to each V value, hence these cases are represented using five bits. An advantage is faster and improved pixel block colouring.

The method may be one in which a lookup table is used to obtain the maximum UV range from the number of bits available to encode the UV values in the encoding scheme. An advantage is faster and improved pixel block colouring.

The method may be one in which the maximum UV range is used, even if the entire maximum range is not needed to encode the UV values. An advantage is faster and improved pixel block colouring.

The method may be one in which if the encoder determines that the pattern in the 8×8 pixel block cannot be represented in this compressed structure, because there aren't enough bits in the compressed structure for successful encoding, the encoding routine returns a value (e.g. zero) indicating that encoding was not possible.

The method may be one in which if in a first attempt, using a horizontal or a vertical snake path, the encoder finds that the pattern in the 8×8 pixel block cannot be represented in this compressed structure, because there aren't enough bits, the encoder tries again, using the other snake path, vertical or horizontal, to see if the pattern in the 8×8 pixel block can be represented in this compressed structure using the other snake path, and if successful, the pattern in the 8×8 pixel block is represented in this compressed structure using the other snake path. An advantage is faster and improved pixel block colouring.

The method may be one including using a codec including a compressed format structure, the compressed format structure including a hierarchy of levels of temporal resolution of colour video frames, each respective level of the hierarchy including colour video frames corresponding to a respective temporal resolution of the respective level of the hierarchy, but not including colour video frames which are included in one or more lower levels of lower temporal resolution of colour video frames of the hierarchy. An advantage is pixel block colouring, with a low chance of a colouring artefact.

The method may be one in which the lowest level (level zero) of the hierarchy are key frames.

The method may be one in which in the next level, (level one) there are delta frames, which are the deltas between the key frames.

The method may be one in which in the next level (level two) there are delta frames, which are the deltas between the level one frames.

The method may be one in which in the next level (level three) there are delta frames, which are the deltas between the level two frames.

The method may be one including 63 frames between two consecutive key frames, where 63=2\hat{ }6−1, in which the hierarchy has levels from level zero to level six. The method may be one in which the compressed data comprises key frames and deltas, in which the deltas have a chain of dependency back to the key frames. The method may be one in which a frame at a particular level includes a backwards-and-forwards flag, which, if set, indicates that the next frame at that particular level is identical to the current frame, hence image data for the next frame at that particular level is not present in the stored frames, and image data for higher level frames (of higher temporal resolution) between the frame at the particular level and the next frame at that particular level is not present in the stored frames. An advantage is pixel block colouring, with a low chance of a colouring artefact.

The method may be one in which a frame at a particular level includes an (e.g. linear) interpolation backwards-and-forwards flag, which, if set, indicates that the next frame at that particular level is obtained by (e.g. linearly) interpolating between the current frame and the next-next frame at that particular level, hence image data for the next frame at that particular level is not present in the stored frames, and image data for higher level frames (of higher temporal resolution) between the frame at the particular level and the next-next frame at that particular level is not present in the stored frames. An advantage is pixel block colouring, with a low chance of a colouring artefact.

The method may be one in which the encoded colour video is displayable on a screen aspect ratio of 16:9.

The method may be one in which the encoded colour video is displayable at 60 fps. The method may be one in which the encoded colour video is displayable by running in javascript, e.g. in a web browser.

The method may be one in which the encoded colour video is editable, e.g. using a video editor program.

The method may be one in which the encoded colour video includes a wipe instruction, which is executable such that one video slides in from one side of the screen, and replaces another video that was playing on the screen. An advantage is faster pixel block colouring.

The method may be one in which the encoded colour video includes a wipe effect, in which one video slides in from one side, and replaces another video that was playing. An advantage is faster pixel block colouring.

The method may be one in which encoded images in encoded 8×8 pixel blocks are used to encode the encoded colour video including the wipe effect. An advantage is faster pixel block colouring.

The method may be one in which processing associated with the wipe is performed using two 240×135 encoded images. An advantage is faster pixel block colouring. The method may be one in which the wipe is a vertical wipe, or the wipe is a horizontal wipe.

The method may be one in which the encoded colour video includes a cross-fade instruction, which is executable such that one video fades-in, and replaces another video that was playing on the screen and which is faded-out. An advantage is faster pixel block colouring.

The method may be one in which the encoded colour video includes a cross-fade effect, in which one video fades-in, and replaces another video that was playing on the screen and which is faded-out. An advantage is faster pixel block colouring.

The method may be one in which encoded images in encoded 8×8 pixel blocks are used to encode the encoded colour video including the cross-fade effect. An advantage is faster pixel block colouring.

The method may be one in which encoded images in linearly-combinable encoded 8×8 pixel blocks are used to encode the encoded colour video including the cross-fade effect. An advantage is faster pixel block colouring.

The method may be one in which processing associated with the cross-fade is performed using two 240×135 representation encoded images. An advantage is faster pixel block colouring.

The method may be one in which processing associated with the cross-fade is performed using a weighted average of two 240×135 representation encoded images.

An advantage is faster pixel block colouring.

The method may be one in which if first and second encoded 8×8 pixel blocks are uniform, or bilinearly interpolated, or contain one edge, a cross fade is performed from the first encoded 8×8 pixel block to the second encoded 8×8 pixel block using a linear fade of the YUV values of the first block YUV values to the second block YUV values. An advantage is faster pixel block colouring.

The method may be one including compressing the encoded video, using transition tables, in which context is used and in which data is used. An advantage is pixel block colouring, with a low chance of a colouring artefact.

The method may be one including when compressing a Y mask, the 8×8 bits Y mask is compressed using eight neighbouring 2×4 bits parts of the Y mask as compression units. An advantage is faster pixel block colouring.

The method may be one in which contents of 2×4 bits parts are predicted using context, in which after a first 2×4 bit part is decompressed, subsequent 2×4 bit parts are predicted using the contents of neighbouring already decompressed 2×4 bit parts. An advantage is faster pixel block colouring.

The method may be one in which subsequent 2×4 bit parts are predicted using the contents of neighbouring bits of already decompressed 2×4 bit parts. An advantage is faster pixel block colouring.

The method may be one in which for the predictions, code words in the transition tables are used.

The method may be one in which the most common arrangements of ones and zeros receive the shortest code words, and the less common arrangements of ones and zeros receive the longer code words, to aid in compression.

The method may be one in which conversion from YUV values to RGB values, or conversion from RGB values to YUV values, is performed using lookup tables. An advantage is faster pixel block colouring.

The method may be one in which two sets of lookup table operations are performed: a first set of lookup table operations for dithering YUV values in a 8×8 pixel block, and a second set of lookup table operations to convert the dithered YUV values to RGB values. An advantage is faster and improved pixel block colouring.

The method may be one in which a corresponding interpolation flag is set if it is determined that interpolation between 8×8 pixel blocks in frames corresponding to different times should be used. An advantage is faster and improved pixel block colouring.

The method may be one in which the interpolation is block type dependent. The method may be one in which if the block types are ones containing an edge, then the position of the edge is interpolated between an earlier frame and a later frame. An advantage is faster and improved pixel block colouring.

The method may be one in which if the block types are bilinear interpolation type, then linear interpolation is performed between an 8×8 pixel block in an earlier frame and a corresponding 8×8 pixel block in a later frame. An advantage is faster and improved pixel block colouring.

The method may be one in which the interpolation is performed between a uniform block and a bilinear interpolation block.

The method may be one in which there are encoded additional, border pixel blocks which are not part of an original image, so that any required information from an adjacent pixel block can be obtained from an additional, border pixel block, at an edge of the image. An advantage is pixel block colouring, with a low chance of a colouring artefact.

The method may be one in which the additional, border pixel blocks are along two adjacent edges of the image.

The method may be one in which the additional, border pixel blocks are not displayed. The method may be one in which for adjusting brightness, brightness is adjusted using 8×8 pixel blocks, in which respective Y values are adjusted to change the brightness, e.g. we can increase Y to increase the brightness. An advantage is pixel block display, with a low chance of a colouring artefact.

The method may be one in which using 8×8 pixel blocks, UV values are adjusted. The method may be one in which adjustment is performed for pixel blocks that are uniform, or linearly interpolated, or which include an edge, or which include a line. The method may be one in which mosaic is created by using 8×8 pixel blocks, with their flags set to indicate uniform pixel blocks, and in which alternate blocks, or alternate groups of blocks, alternate between two colours.

The method may be one in which a mosaic is encoded which does not align with (e.g. is not whole number multiples of) the 8×8 pixel blocks, including use of non-uniform 8×8 pixel blocks in the encoding.

The method may be one including a method of finding an edge, in which in a first step an 8×8 pixel block is calculated in which the pixels are evaluated using bilinear interpolation based on the four corner colours C1, C2, C3 and C4; in a second step an 8×8 difference pixel block is computed that is the difference between the 8×8 original pixel block and the 8×8 pixel block in which the pixels are evaluated using bilinear interpolation based on the four corner colours C1, C2, C3 and C4; when the original pixel block includes an image of an edge, then the 8×8 difference pixel block has one area where the values are positive, and an adjacent area where the values are negative, and at the midpoints between where the values are positive, and where the values are negative, a position of an edge is inferred. An advantage is fast and accurate edge identification.

The method may be one including a method of finding a line, in which in a first step an 8×8 pixel block is calculated in which the pixels are evaluated using bilinear interpolation based on the four corner colours C1, C2, C3 and C4; in a second step an 8×8 difference pixel block is computed that is the difference between the 8×8 original pixel block and the 8×8 pixel block in which the pixels are evaluated using bilinear interpolation based on the four corner colours C1, C2, C3 and C4; when the original pixel block includes an image of a line, then the 8×8 difference pixel block has one line area where the values are all positive or all negative, or nearly all positive, or nearly all negative, and an adjacent area where the values are zero, or close to zero, and at the line area where the values are all positive or all negative, or nearly all positive, or nearly all negative, a position of a line is inferred. An advantage is fast and accurate line identification.

The method may be one in which when a line is encoded in the data structure, for a corresponding flag value, one bit in the data is used to indicate if the line is light or dark with respect to its surroundings.

The method may be one in which further bits are used to indicate the degree of lightness or darkness of the line with respect to its surroundings.

The method may be one in which a line default colour is black.

The method may be one in which motion detection is performed by analysing the edges in video frames, by analysing 8×8 pixel blocks in video frames which are block types including one or more edges. An advantage is fast and accurate motion detection.

The method may be one including analysing 8×8 pixel blocks in video frames which are block types including two edges. An advantage is fast and accurate motion detection.

The method may be one including analysing 8×8 pixel blocks in video frames which are block types including two edges to yield information about both orthogonal components of the motion vector. An advantage is fast and accurate motion detection. The method may be one including analysing 8×8 pixel blocks in video frames which are block types including two edges to yield information about both orthogonal components of the motion vector, and any angle change, or rotation, θ. An advantage is fast and accurate motion detection.

The method may be one in which LUTs are used for rotation detection. An advantage is fast and accurate motion detection.

The method may be one in which a LUT is used in which receiving an edge pair at the lookup table provides a two dimensional translation X, Y and an angle change θ of the edge, in return, where the pair is the edge type in the pixel block of the video frame, and the edge type in the pixel block of a next video frame. An advantage is fast and accurate motion detection.

The method may be one in which if the detected angle change is greater in magnitude than a threshold value, this is used to reject the candidate match between detected edges of a video frame, and of a next video frame.

The method may be one in which returned X, Y and 0 values are analysed to find consistent areas between the video frame, and a next video frame, to detect motion. The method may be one in which a motion vector is stored for a group of blocks, or for a consistent area, so that the number of motion vectors that are stored is greatly reduced, compared to the case of storing a motion vector for each block.

The method may be one in which detecting a 0 for the whole image is interpreted as camera rotation, and this rotation is removed, which is an example of a “steady camera” or “steadicam” function.

According to a second aspect of the invention, there is provided a computer program product executable on a processor to encode a colour video, the colour video comprising colour video frames, the colour video frames including 1920 pixels by 1080 pixels, the computer program product executable on the processor to: (i) encode colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits.

The computer program product may be executable on the processor to perform a method of any aspect of the first aspect of the invention.

According to a third aspect of the invention, there is provided a device configured to encode a colour video, the colour video comprising colour video frames, the colour video frames including 1920 pixels by 1080 pixels, the device configured to encode the colour video according to a method of any aspect of the first aspect of the invention.

The device may be one wherein the device is configured to capture a video stream and to encode the colour video using the video stream.

According to a fourth aspect of the invention, there is provided a computer-implemented method of encoding a colour video, the colour video comprising colour video frames, the colour video frames including 640 pixels by 360 pixels, the method including the step of:

(i) encoding colour video frames using a 80 elements by 45 elements representation of the 640 pixels by 360 pixels, each element comprising an encoded 8×8 pixel block, wherein each encoded 8×8 pixel block is represented using a representation including a codeword, the codeword including 64 bits. An advantage is that the encoded colour video can be decoded and displayed, in real-time, on a display including 640 pixels by 360 pixels, of a common computer device such as a smartphone, a tablet computer, a laptop computer or a desktop computer, in a browser, executing javascript code. An advantage is that the encoded colour video requires less energy to transmit than alternative compression schemes producing similar display quality when decompressed, which saves energy, which is environmentally beneficial.

The method may be one including a step of any aspect of the first aspect of the invention.

According to a fifth aspect of the invention, there is provided a computer-implemented method of decoding to generate a colour video, the colour video comprising colour video frames, the colour video frames including 1920 pixels by 1080 pixels, the method including the step of:

(i) decoding colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits, wherein the representation is decoded.

An advantage is that the encoded colour video can be decoded and displayed, in real-time, on a display including 1920 pixels by 1080 pixels, of a common computer device such as a smartphone, a tablet computer, a laptop computer or a desktop computer, e.g. in a browser, executing javascript code. An advantage is that the encoded colour video requires less energy to transmit than alternative compression schemes producing similar display quality when decompressed, which saves energy, which is environmentally beneficial.

The method may be one wherein the decoding includes decoding a video encoded using the method of any aspect of the first aspect of the invention.

The method may be one including playing the decoded video on a computer including a display, the display including 1920 pixels by 1080 pixels, e.g. playing the decoded video on a smart TV, a video display headset, a desktop computer, a laptop computer, a tablet computer or a smartphone, e.g. in which the encoded video is received via the internet, e.g. in which the encoded video is received via internet streaming.

The method may be one wherein the decoded video is playable using javascript, e.g. in a web browser.

The method may be one wherein the decoded video is playable using an app, e.g. running on a smartphone.

The method may be one wherein the decoded video is playable at 60 fps, and at 30 bpp colour depth.

The method may be one wherein the decoded video is rendered in real-time.

The method may be one wherein the encoded video includes lossy encoding. The method may be one wherein in the codeword, colour is represented using at least ten bits each for YUV.

The method may be one wherein in the codeword, colour is represented using at least ten bits each for RGB.

The method may be one wherein the codeword comprises 64 bits including a codeword type, with zero or more extension codewords depending on the codeword type specified.

The method may be one wherein each 64 bit codeword representing its 8×8 pixel block has its own type and list of zero or more extensions.

The method may be one wherein the codeword consists of exactly 64 bits. An advantage is that this codeword size is processed efficiently by processors. The method may be one wherein the codeword includes 64 bits, comprising a flag including at least 4 bits, data bits e.g. 30 bits of data, and 30 bits to represent ten bits each for the Y value, the U value and the V value, or ten bits each for the R value, the G value and the B value.

The method may be one wherein one or more bits in the (e.g. 30 data) bits is used as an extension pointer, which points to extension block(s) which include extra data, for use with specific flag values, which correspond to encoded 8×8 pixel blocks including image data that is too complex to represent accurately in a standard 64 bit codeword. The method may be one wherein some encoded 8×8 pixel blocks are represented using a representation including a codeword, the codeword including 64 bits, the representation further including an extension block, e.g. including 64 bits. An advantage is more complex pixel blocks can be displayed.

The method may be one wherein the extension block consists of exactly 64 bits. An advantage is that this extension block size is processed efficiently by processors. The method may be one wherein a codeword unique flag value corresponds to a uniform block, with a colour given by the 30 bits that represent colour.

The method may be one in which the data part of the uniform block codeword is all zeros, or all ones, because there is no data.

The method may be one wherein a codeword unique flag value corresponds to a bilinear interpolation, in which four colour values are used to perform a bilinear interpolation, the four colour values including one colour for each corner, in which one colour value for one corner is represented in the codeword, and the other three colours are obtained from the codewords for blocks neighbouring the other three corners. An advantage is that these block types are processed efficiently by a processor.

The method may be one in which the data part of the bilinearly interpolated block codeword is all zeros, or all ones, because there is no data.

The method may be one in which the bilinear interpolation is performed when moving in a direction by adding a first constant value, and the bilinear interpolation is performed when moving orthogonal to the direction by adding a second constant value.

The method may be one in which a bilinearly interpolated encoded 8×8 pixel block is defined using dithering.

The method may be one in which using dithering and LUTs when decoding encoded 8×8 pixel blocks when receiving bilinearly interpolated blocks, includes not performing bilinear interpolation calculations.

The method may be one including using the instructions ADD64 R4, R0, R0<<32; ST64 R4, [image]; ADD64 R4, R1, R2<<32; ST64 R4, [image+2]; in which each 64-bit store stores two pixels, and in which the blocks are uniform blocks or bilinearly interpolated blocks with dither. An advantage is that these block types are processed efficiently by a processor.

The method may be one wherein a codeword unique flag value corresponds to an encoded 8×8 pixel block including a single edge, the single edge position defined by 9 or 10 bits in the data bits. An advantage is that these block types are processed efficiently by a processor.

The method may be one in which for each pixel, a dither value is stored using three bits.

The method may be one in which an edge type identifier is given for a 8×8 pixel block in which an edge passes directly through a corner.

The method may be one in which the edge types do not exceed 512, and hence are represented using 9 bits. An advantage is that these block types are processed efficiently by a processor.

The method may be one in which to decode encoded data, for the case of a 8×8 encoded pixel block including an edge, the pixel block has a known colour at each of its four corners, the known colours being C1, C2, C3 C4; a lookup table is used which is a function of the edge number, which is a number which particularizes where in the pixel block the line representing the edge starts and finishes; the lookup table is at least 128 Bits, which is at least two bits per pixel of the 8×8 pixel block, where 2×8×8=128; the two bits can take values 00, 01, 10 and 11, which correspond respectively to colours C1, C2, C3, C4; the lookup table is used to determine which corner colour value to use for each particular pixel in the decoded pixel block; dithering is used when rendering the pixels in the decoded pixel block. An advantage is pixel block colouring, with a low chance of a colouring artefact.

The method may be one in which the 8×8 pixel block edge is a blurred edge, which has a different edge number to a corresponding 8×8 pixel block with a non-blurred edge, where the 8×8 pixel block including a blurred edge has a lookup table corresponding to its edge number which is a blurred edge number. An advantage is pixel block colouring, with a low chance of a colouring artefact.

The method may be one including a method of colouring-in an 8×8 pixel block, which includes one corner which is on the opposite side of an edge to the other three corners, in which the 8×8 pixel block is coloured-in using dithering using a lookup table, including using a fake colour value C1′ for the corner which is on the opposite side of an edge to the other three corners, when colouring in the region that is on the side of the edge of the three corners. An advantage is pixel block colouring, with a low chance of a colouring artefact.

The method may be one in which the fake corner colour is signified using one bit of three bits denoting colour.

The method may be one in which the fake colour C1′=C2+C3-C4, in which the pixel block corner colours are C1, C2, C3 and C4.

The method may be one in which the dither values for each pixel as a function of edge position, for all possible edge positions, are stored in lookup tables. An advantage is faster and improved pixel block colouring.

The method may be one in which edges include soft edges, or edges include hard edges, or edges include soft edges and hard edges.

The method may be one in which in the case of a soft edge, for an 8×8 pixel block which is coloured-in using dithering using a lookup table, some pixels in the part of the 8×8 pixel block for the corner closest to the edge are coloured in using not the colour of the corner closest to the edge, but using colours from the other corners. An advantage is faster and improved pixel block colouring.

The method may be one including using a lookup table to determine which of the four corner colours to insert for a given pixel. An advantage is faster and improved pixel block colouring.

The method may be one in which the stored lookup tables require 12 to 16 kbytes of memory. An advantage is faster pixel block colouring.

The method may be one in which the dither lookup tables include lookup tables for 8×8 pixel blocks including a soft edge. An advantage is faster and improved pixel block colouring.

The method may be one in which for a soft edge, some pixels in the part of the 8×8 pixel block for the corner closest to the edge are coloured in using not the colour of the corner closest to the edge, but using colours from the other corners. An advantage is faster and improved pixel block colouring.

The method may be one in which the dither lookup tables include lookup tables for 8×8 pixel blocks including a hard edge. An advantage is faster and improved pixel block colouring.

The method may be one in which dither lookup tables include lookup tables for 8×8 pixel blocks including a line. An advantage is faster and improved pixel block colouring.

The method may be one in which dither lookup tables are stored in a cache. An advantage is faster pixel block colouring.

The method may be one in which the dither lookup tables are stored in a cache in a processing chip (e.g. CPU). An advantage is faster pixel block colouring.

The method may be one in which the dither lookup tables are stored in a level 1 (L1) cache in the processing chip (e.g. CPU). An advantage is faster pixel block colouring. The method may be one in which the L1 cache includes only the lookup tables of the types of 8×8 pixel blocks including an edge which are included in the present video frame.

The method may be one in which the L1 cache includes the lookup tables of the types of 8×8 pixel blocks including an edge which are included in the present video frame, and does not include some or all of the lookup tables of the types of 8×8 pixel blocks including an edge for the types of 8×8 pixel blocks including an edge which are not included in the present video frame.

The method may be one in which for each of the four colour values of the lookup table, a set of four binary mask elements is defined, each being all ones or all zeros; these four mask elements are then used in a logical AND operation with the four corner colours C1, C2, C3 and C4, and the results are summed, to give a single colour for each value of the lookup table; the resulting colour value, which is one of C1, C2, C3 and C4, is then inserted into the pixel of the 8×8 pixel block. An advantage is faster pixel block colouring.

The method may be one which is implemented in javascript.

The method may be one including loading the four corner colours C1, C2, C3 and C4 into consecutive memory addresses; loading the required pixel colour based on the corresponding two bit address, taken from a lookup table value, using a command such as LDR result, [2 bit offset], and performing this in two processor clock cycles, for two pixels. An advantage is faster pixel block colouring.

The method may be one in which the LUTs are incorporated into executable computer code. An advantage is faster and improved pixel block colouring.

The method may be one in which for colouring in parts of an edge image in a pixel block, if the part of the edge image contains only one corner, then the specified colour is provided uniformly for the part of the edge image including that one corner; if the part of the edge image contains two corners, then linear interpolation is used to colour in the part of the edge image including the two corners, based on the colours associated with the respective corners, from the pixel block itself, or from adjacent pixel blocks; if the part of the edge image contains three corners, then bilinear interpolation is used to colour in the part of the edge image including the three corners, based on the colours associated with the respective corners, from the pixel block itself, or from adjacent pixel blocks. An advantage is pixel block colouring, with a low chance of a colouring artefact.

The method may be one in which a codeword unique flag value corresponds to an 8×8 block including two edges comprising a first edge and a second edge, in which the second edge is placed on top of the first edge. An advantage is faster and improved pixel block colouring.

The method may be one in which the first edge and the second edge are at any angle to each other which is permitted by the 8×8 pixel block geometry. An advantage is faster and improved pixel block colouring.

The method may be one in which a codeword unique flag value corresponds to an 8×8 block including one line. An advantage is faster and improved pixel block colouring. The method may be one in which either side of the line, the pixels are bilinearly interpolated. An advantage is pixel block colouring, with a low chance of a colouring artefact.

The method may be one in which the pixels are bilinearly interpolated using the colour values of the four corners. An advantage is faster and improved pixel block colouring.

The method may be one in which the pixel block is one in which the line has a line colour, and either side of the line the same or a similar non-line colour is decoded from the encoding. An advantage is pixel block colouring, with a low chance of a colouring artefact.

The method may be one in which a codeword unique flag value corresponds to an 8×8 block including texturing two YUV values, or to texturing two RGB values; the 30 bit data contains the offset to the YUV or RGB value encoded in the colour 30 bits of the 64 bit codeword. An advantage is faster and improved pixel block colouring.

The method may be one in which a contrast is encoded in extra data (e.g. +/−8 grey scales), and an offset to the mask is encoded in extra data, in which case data additional to the 64 bit codeword is used, in an extension block, to store the information. An advantage is pixel block colouring, with a low chance of a colouring artefact.

The method may be one wherein which of the two textures to use in each pixel of the 8×8 pixel block is encoded with a ‘1’ or a zero for each pixel, hence using 8×8-64 bits. An advantage is pixel block colouring, with a low chance of a colouring artefact. The method may be one in which a codeword unique flag value corresponds to an 8×8 block including texturing three YUV or RGB values; the main colour value is the YUV or RGB value encoded in the 30 colour bits of the codeword; then there is a plus offset to the YUV or RGB value, that is encoded in 30 bits, and a minus offset to the YUV or RGB value that is encoded in 30 bits; in this case, the codeword plus extension block(s) is at least 128 bits long, so it can include all the required data. An advantage is improved pixel block colouring.

The method may be one in which two bits are used to represent which of the three textures corresponds to each pixel of the 8×8 pixel block, so this is encoded using two bits for each pixel, hence using 8×8×2=128 bits. An advantage is faster and improved pixel block colouring.

The method may be one in which a codeword unique flag value corresponds to an 8×8 block including no compression.

The method may be one in which a codeword unique flag value corresponds to an 8×8 block for representing an e.g. irregular, shape, the codeword including a 64 bit mask (a “Y mask”) which stores if the Y values should be increased (plus) or decreased (minus) relative to the average Y value of the 8×8 pixel block; there is stored the increase in the Y value, where the Y value is increased; there are stored, in e.g. 20 bits, the UV value (e.g. 10 bits each for U and V), for use when the Y value is increased, and there are stored, e.g. in a further 20 bits, the UV value (10 bits each for U and V) for use when the Y value is decreased, e.g. leading to a total of 40 bits for the increased Y's UV value and for the decreased Y's UV value. An advantage is faster and improved pixel block colouring.

The method may be one in which the negative of the stored increase in the Y value, is used to decrease the Y value, where the Y value is decreased.

The method may be one in which there is decoded a decrease in the Y value, which is used to decrease the Y value, where the Y value is decreased. An advantage is pixel block colouring, with a low chance of a colouring artefact.

The method may be one in which the Y mask, the UV value for use when the Y value is decreased, and the UV value for use when the Y value is decreased, are decompressed. An advantage is faster and improved pixel block colouring.

The method may be one in which the Y mask, the UV value for use when the Y value is decreased, and the UV value for use when the Y value is decreased, are decompressed losslessly. An advantage is pixel block colouring, with a low chance of a colouring artefact.

The method may be one in which the Y mask is decompressed using run-length encoding, in a snake path across the 8×8 pixel block. An advantage is faster and improved pixel block colouring.

The method may be one in which the snake path is a horizontal snake path.

The method may be one in which the snake path is a vertical snake path.

The method may be one in which the run-length encoding decodes the length using three bits, including 000 to 110 denoting a sequence of up to six of the same sign, with 111 denoting that the sequence is too long to be encoded in the three bits and carries on such that the next three bit value needs to be followed. An advantage is faster and improved pixel block colouring.

The method may be one in which for the first entry, decimal zero to six are used to represent a sequence of one to seven of the same sign.

The method may be one in which sat the end of the data for the Y mask, if there is a single final pixel which has not been specified, it is assumed that the sign changes for the single final pixel, and that the UV value is that for the 8×8 pixel block. The method may be one in which header bits are used, to decode whether the first pixel is a plus or a minus, and whether the snake path is horizontal or vertical, and a UV differ flag. An advantage is faster and improved pixel block colouring. The method may be one in which the UV differ flag indicates whether or not the increased Y's UV value and the decreased Y's UV value are the same.

The method may be one in which if the UV values are not the same, then there is decoded from the compressed structure the range of UV values, relative to the UV value of the 8×8 pixel block, wherein the representation of the compression of the UV values in the compressed structure fit in the available number of bits in the data structure after the Y mask values have been decoded. An advantage is faster and improved pixel block colouring.

The method may be one in which if the UV range is from −1 to 0, or from 0 to +1, this is decoded using a first bit which distinguishes between these two possibilities, and using four times one bit, about whether the change applies to each U and to each V value, hence these cases are represented in the encoding using five bits. An advantage is faster pixel block colouring.

The method may be one in which the maximum UV range is used, even if the entire maximum range is not needed to encode the UV values.

The method may be one in which when decoding, it is assumed the maximum range is being used, because there is no information about what the range is.

The method may be one in which a lookup table is used to obtain the maximum UV range from the number of bits available when decoding the UV values. An advantage is faster pixel block colouring.

The method may be one in which in the decoding scheme, the maximum UV range is used, even if the entire maximum range is not needed to decode the UV values.

The method may be one in which decoding the Y mask values and the UV values is lossless. An advantage is faster and improved pixel block colouring.

The method may be one including using a codec including a compressed format structure, the compressed format structure including a hierarchy of levels of temporal resolution of colour video frames, each respective level of the hierarchy including colour video frames corresponding to a respective temporal resolution of the respective level of the hierarchy, but not including colour video frames which are included in one or more lower levels of lower temporal resolution of colour video frames of the hierarchy. An advantage is pixel block colouring, with a low chance of a colouring artefact.

The method may be one in which the lowest level (level zero) of the hierarchy are key frames.

The method may be one in which in the next level, (level one) there are delta frames, which are the deltas between the key frames.

The method may be one in which in the next level (level two) there are delta frames, which are the deltas between the level one frames.

The method may be one in which in the next level (level three) there are delta frames, which are the deltas between the level two frames.

The method may be one in which the compressed format structure includes 63 frames between two consecutive key frames, where 63=2\hat{ }6−1, wherein the hierarchy has levels from level zero to level six.

The method may be one wherein the compressed data comprises key frames and deltas, in which the deltas have a chain of dependency back to the key frames. The method may be one wherein a frame at a particular level includes a backwards-and-forwards flag, which, if set, indicates that the next frame at that particular level is identical to the current frame, hence image data for the next frame at that particular level is not present in the stored frames, and image data for higher level frames (of higher temporal resolution) between the frame at the particular level and the next frame at that particular level is not present in the stored frames. An advantage is faster and improved pixel block colouring.

The method may be one, wherein a frame at a particular level includes an (e.g. linear) interpolation backwards-and-forwards flag, which, if set, indicates that the next frame at that particular level is obtained by (e.g. linearly) interpolating between the current frame and the next-next frame at that particular level, hence image data for the next frame at that particular level is not present in the stored frames, and image data for higher level frames (of higher temporal resolution) between the frame at the particular level and the next-next frame at that particular level is not present in the stored frames. An advantage is faster and improved pixel block colouring.

The method may be one, wherein the decoded colour video is displayed on a screen aspect ratio of 16:9.

The method may be one wherein the decoded colour video is displayed at 60 fps.

The method may be one wherein the decoded colour video is displayed by running in javascript.

The method may be one wherein the decoded colour video is editable, e.g. using a video editor program.

The method may be one wherein the decoded colour video includes a wipe instruction, which is executable such that one video slides in from one side of the screen, and replaces another video that was playing on the screen.

The method may be one wherein the decoded colour video includes a wipe effect, in which one video slides in from one side, and replaces another video that was playing.

An advantage is faster and improved pixel block colouring.

The method may be one in which decoded images in decoded 8×8 pixel blocks are played to play the colour video including the wipe effect. An advantage is faster and improved pixel block colouring.

The method may be one wherein processing associated with the wipe is performed using two 240×135 encoded images. An advantage is faster and improved pixel block colouring.

The method may be one wherein the wipe is a vertical wipe, or the wipe is a horizontal wipe.

The method may be one wherein the wipe is performed in real time, using javascript.

The method may be one wherein the decoded colour video includes a cross-fade instruction, which is executable such that one video fades-in, and replaces another video that was playing on the screen and which is faded-out. An advantage is faster and improved pixel block colouring.

The method may be one wherein the decoded colour video includes a cross-fade effect, in which one video fades-in, and replaces another video that was playing on the screen and which is faded-out.

The method may be one in which decoded images in decoded 8×8 pixel blocks are played to play the colour video including the cross-fade effect.

The method may be one in which encoded images in linearly-combinable encoded 8×8 pixel blocks are used to play the encoded colour video including the cross-fade effect. An advantage is faster and improved pixel block colouring.

The method may be one wherein processing associated with the cross-fade is performed using two 240×135 representation encoded images. An advantage is faster and improved pixel block colouring.

The method may be one wherein processing associated with the cross-fade is performed using a weighted average of two 240×135 representation encoded images. An advantage is faster and improved pixel block colouring.

The method may be one in which if first and second encoded 8×8 pixel blocks are uniform, or bilinearly interpolated, or contain one edge, a cross fade is performed from the first encoded 8×8 pixel block to the second encoded 8×8 pixel block using a linear fade of the YUV values of the first block YUV values to the second block YUV values.

The method may be one in which the cross-fade effect is performed in real time, using javascript.

The method may be one in which the cross-fade effect rendering is performed on a display, so there is no storage of images intermediate to the two source images, and the displayed cross-faded image. An advantage is faster pixel block colouring.

The method may be one including decompressing the encoded video, using transition tables, in which context is used and in which data is used. An advantage is faster and improved pixel block colouring.

The method may be one wherein when decompressing a Y mask, the 8×8 bits Y mask is decompressed using eight 2×4 bits parts of the Y mask as decompression units. An advantage is faster pixel block colouring.

The method may be one in which contents of 2×4 bits parts are predicted using context, in which after a first 2×4 bit part is decompressed, subsequent 2×4 bit parts are predicted using the contents of neighbouring already decompressed 2×4 bit parts. An advantage is faster pixel block colouring.

The method may be one in which subsequent 2×4 bit parts are predicted using the contents of neighbouring bits of already decompressed 2×4 bit parts. An advantage is faster pixel block colouring.

The method may be one, in which for the predictions, code words in the transition tables are used. An advantage is faster pixel block colouring.

The method may be one, in which the most common arrangements of ones and zeros use the shortest code words, and the less common arrangements of ones and zeros use the longer code words, to aid in decompression. An advantage is faster pixel block colouring.

The method may be one, in which conversion from YUV values to RGB values, or conversion from RGB values to YUV values, is performed using lookup tables.

The method may be one, in which two sets of lookup table operations are performed: a first set of lookup table operations for dithering YUV values in a 8×8 pixel block, and a second set of lookup table operations to convert the dithered YUV values to RGB values. An advantage is pixel block colouring, with a low chance of a colouring artefact.

The method may be one, in which RGB values are used for the actual display step on a display.

The method may be one, in which a corresponding interpolation flag that is set determines that interpolation between 8×8 pixel blocks in frames corresponding to different times is used. An advantage is faster pixel block colouring.

The method may be one, in which the interpolation is block type dependent.

The method may be one, in which if the block types are ones containing an edge, then the position of the edge is interpolated between an earlier frame and a later frame.

The method may be one, in which if the block types are bilinear interpolation type, then linear interpolation is performed between an 8×8 pixel block in an earlier frame and a corresponding 8×8 pixel block in a later frame.

The method may be one, in which interpolation is performed between a uniform block and a bilinear interpolation block.

The method may be one, in which there are decoded additional, border pixel blocks which are not part of an original image, so that, when decoding, any required information from an adjacent pixel block is obtained from an additional, border pixel block, at an edge of the image. An advantage is pixel block colouring, with a low chance of a colouring artefact.

The method may be one, in which the additional, border pixel blocks are along two adjacent edges of the image.

The method may be one, in which the additional, border pixel blocks are not displayed.

The method may be one, in which to adjust brightness, brightness is adjusted using 8×8 pixel blocks, in which the Y value is adjusted to change the brightness, e.g. we can increase Y to increase the brightness. An advantage is faster pixel block rendering. The method may be one, in which using 8×8 pixel blocks, UV values are adjusted. The method may be one, in which the adjustment is performed for pixel blocks that are uniform, or linearly interpolated, or which include an edge, or which include a line. An advantage is faster pixel block rendering.

The method may be one, in which the adjustment is performed using a video editor program.

The method may be one, in which mosaic is created by using 8×8 pixel blocks, with their flags set to indicate uniform pixel blocks, and in which alternate blocks, or alternate groups of blocks, alternate between two colours.

The method may be one, in which mosaic which does not align with (e.g. is not whole number multiples of) the 8×8 pixel blocks, including use of non-uniform 8×8 pixel blocks.

The method may be one, in which when a line is encoded in the data structure, for a corresponding flag value, one bit in the data is used to indicate if the line is light or dark with respect to its surroundings. An advantage is pixel block colouring, with a low chance of a colouring artefact.

The method may be one in which further bits are used to indicate the degree of lightness or darkness of the line with respect to its surroundings. An advantage is pixel block colouring, with a low chance of a colouring artefact.

The method may be one in which a line default colour is black.

The method may be one in which a motion vector is stored for a group of blocks, or for a consistent area, so that the number of motion vectors that are stored is greatly reduced, compared to the case of storing a motion vector for each block. An advantage is faster and improved pixel block colouring.

The method may be one wherein decoding the video does not use a Fourier transform.

An advantage is pixel block colouring, with a low chance of a colouring artefact. The method may be one wherein to display decompressed video at a display, decompressed video is generated by a central processing unit (CPU), and is sent for display on a display e.g. on a display that is 1080p, e.g. at 60 frames per second (fps), without using a GPU. An advantage is lower energy video display.

The method may be one further including a method of encoding a colour video of any aspect of the first aspect of the invention.

According to a sixth aspect of the invention, there is provided a computer program product executable on a processor to decode to generate a colour video, the colour video comprising colour video frames, the colour video frames including 1920 pixels by 1080 pixels, the computer program product executable on the processor to:

(i) decode colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits, wherein the representation is decoded.

The computer program product may be executable on the processor to perform a method of any aspect of the fifth aspect of the invention.

According to a seventh aspect of the invention, there is provided a device configured to decode a colour video, the colour video comprising colour video frames, the colour video frames including 1920 pixels by 1080 pixels, the device configured to decode the colour video according to a method of any aspect of the fifth aspect of the invention.

The device may be one including a display including 1920 pixels by 1080 pixels wherein the device is configured to display the decoded colour video on the display.

According to an eighth aspect of the invention, there is provided a computer-implemented method of decoding to generate a colour video, the colour video comprising colour video frames, the colour video frames including 640 pixels by 360 pixels, the method including the step of:

(i) decoding colour video frames using a 80 elements by 45 elements representation of the 640 pixels by 360 pixels, each element comprising an encoded 8×8 pixel block, wherein each encoded 8×8 pixel block is represented using a representation including a codeword, the codeword including 64 bits, wherein the representation is decoded.

The method may be one including a step of any aspect of the fourth or fifth aspects of the invention.

Aspects of the invention may be combined. A computer processing result may be stored. The computer-implemented methods of encoding a video described above include the advantage of energy reduction, because the encoding typically greatly reduces the amount of data which is transmitted for subsequent decoding, compared to other methods of encoding a video. The computer-implemented methods of decoding a video described above include the advantage of energy reduction, because the related encoding typically greatly reduces the amount of data which is received to perform the decoding, compared to other methods of encoding a video.

### BRIEF DESCRIPTION OF THE FIGURES

Aspects of the invention are described, by way of example(s), with reference to the following Figures, in which:

FIG. 1 shows an example of memory usage by the editor/player associated with a video codec.

FIG. 2 shows an example in which a 1920×1080 image is stored in a 240×135 array, in 8×8 compressed pixel blocks, where each 8×8 compressed pixel block is represented by a codeword of 64 bits.

FIG. 3 shows an example in which a horizontal wipe video effect is performed.

FIG. 4 shows an example in which a 64 bit codeword is used for an 8×8 pixel block.

FIG. 5 shows an example in which a bilinear interpolation is performed for an 8×8 pixel block.

FIG. 6 shows an example in which a bilinear interpolation is performed for an 8×8 pixel block.

FIG. 7 shows an example of an 8×8 pixel block including an image of an edge.

FIG. 8 shows an example of an 8×8 pixel block including an image of an edge, in which the corners have respective colours C1, C2, C3 and C4, in which the area between the edge and the corner with colour C1 is coloured C1, and in which the rest of the area of the 8×8 pixel block is coloured using bilinear interpolation between the colours C2, C3 and C4.

FIG. 9 shows an example of an 8×8 pixel block including an image which includes two edges.

FIG. 10 is an example of a lookup table for an 8×8 pixel block image of an edge, including two bits per pixel, where each two bit entry corresponds to a colour of one of the four corners, in which the lookup table is used to colour in the 8×8 pixel block, including dithering. Not all two bit entries are shown.

FIG. 11A shows a conventional approach to displaying decompressed video at a display.

FIG. 11B shows an example of a lower energy approach to displaying decompressed video at a display, when compared to FIG. 11A.

FIG. 12 shows an example in which additional, border pixel blocks are included at two adjacent edges of an image.

FIG. 13 shows an example in which for each of the four values of the lookup table, a set of four mask elements is defined, each being all ones or all zeros. These four mask elements are then used in a logical AND operation with the four corner colours C0, C1, C2 and C3, and the results are summed, to give a single colour for each value of the lookup table.

FIG. 14 shows an example in which the four corner colours C0, C1, C2 and C3 are loaded into consecutive memory addresses.

FIG. 15 shows an example in which the rows row0 and row1 of the lookup table are shown.

FIG. 16 shows an example in which a vertical wipe video effect is performed.

FIG. 17 shows an example of an 8×8 pixel block including an image of an edge, in which the corners have respective colours C1, C2, C3 and C4.

FIG. 18 shows an example of an inferred edge in a pixel block.

FIG. 19 shows an example of an inferred line in a pixel block.

FIG. 20 shows an example of an inferred motion vector of an edge in a video frame.

FIG. 21 shows an example of an inferred motion vector of two edges in a video frame, including an inferred rotation 0.

FIG. 22 shows an example of a lookup table for a soft edge, overlaid on a 8×8 pixel block including the soft edge.

FIG. 23 shows an example of a 8×8=64 bit Y mask.

FIG. 24 shows an example in which the colour C1 for a corresponding corner is evaluated by averaging pixels inside the dashed shape, which includes some pixels in neighbouring 8×8 pixel blocks (neighbouring pixel blocks not shown), so as not to use pixels in the 8×8 pixel block which are on the opposite side of the edge compared to the corner with colour value C1, and so as not to use pixels outside the 8×8 block which are symmetric, relative to the corner with colour value C1, with the area of pixels in the 8×8 pixel block which is on the opposite side of the edge to the corner with colour C1.

FIG. 25 shows an example in which the colour at a corner is, or can be, determined by averaging the colours in an 8×8 pixel area centred on the corner.

FIG. 26 shows an example in which the colour C1 for a corner through which an edge passes is evaluated using the colours of the other three corners C2, C3, C4 though which the edge does not pass.

FIG. 27 shows an example in which instead of using only the known corner colour values C2, C3 and C4 to colour-in the region on the opposite side of the edge to the corner with colour C1 (FIG. 27 left hand side), the colours C1′, C2, C3 and C4, can be dithered to obtain an improved colouring-in for the region on the opposite side of the edge to the corner with colour C1 (FIG. 27 right hand side).

FIG. 28A shows an example of a horizontal snake path. FIG. 28B shows an example of a vertical snake path.

FIG. 29A shows an example of a 8×8-64 bit Y mask. FIG. 29B shows an example of a 8×8-64 bit Y mask.

FIG. 30A shows an example of a 8×8 Y mask divided into eight 2×4 parts, suitable for compression. FIG. 30B shows an example diagram of 2×4 parts of a 8×8 Y mask, in which for each 2×4 part except the top left part, the arrows indicate which neighbouring 2×4 part(s) the 2×4 part uses to predict the values in the 2×4 part.

FIGS. 31A to 31D show examples of predicting the binary values of a 2×4 part on the right based on the two rightmost binary values of a 2×4 part on the left; only the two rightmost binary values of the 2×4 part on the left are shown.

FIG. 32 shows an example of predicting the binary values of a 2×4 part on the right based on the two rightmost binary values of a 2×4 part on the left (only the two rightmost binary values of the 2×4 part on the left are shown), and based on the bottom row of a 2×4 part above the 2×4 part on the right (only the bottom row binary values of the 2×4 part above the 2×4 part on the right are shown).

FIG. 33A is a schematic diagram of a sequence of video frames.

FIG. 33B is a schematic diagram illustrating an example of a construction of a delta frame.

FIG. 34 is a schematic diagram of an example of a media player.

FIG. 35A shows a typical image of 376×280 pixels divided into 8×8 pixel super-blocks.

FIG. 35B shows a typical super-block of 8×8 pixels divided into 64 pixels.

FIG. 35C shows a typical mini-block of 2×2 pixels divided into 4 pixels.

FIG. 36 shows an example image containing two Noah regions and a Noah edge.

### DETAILED DESCRIPTION

### Video Codec

An earlier video codec, Blackbird 5, was aimed at 180p class images, the resolution being 320×180, with 57,600 pixels, and a screen aspect ratio of 16:9. The images were displayed using Java, at 30 fps (frames per second), at 16 bpp (bits per pixel) colour depth or 20 bpp colour depth.

A later video codec, Blackbird 9, is aimed at 360p class images, the resolution being 640×360, with 230,400 pixels, and a screen aspect ratio of 16:9. The images are displayed using Javascript (which is about three times slower than Java), at 30 or 60 fps (frames per second), at 24 bpp (bits per pixel) colour depth. Computationally, this is 12-24 times more demanding than for Blackbird 5.

An aim is to provide a new video codec that will run for 1080p class images, the resolution being 1920×1080, with about 2.1 megapixels, and a screen aspect ratio of 16:9. The images should typically be displayed using Javascript, at 60 fps (frames per second), at 30 bpp (bits per pixel) colour depth, which is e.g. 10 bits each for red, green and blue. 2.1 megapixels at 60 fps is about 120 million pixels per second. Computationally, this is about 10 times more demanding than for Blackbird 9. And note that we typically run in javascript which can process about 1 billion instructions per second on a 5 GHz CPU.

There are also challenges regarding memory usage, for this new video codec. This new video codec may or must permit editing, and not just provide play back, for example to provide rendering, e.g. real-time rendering. The video player may include an editor. The video player downloads data to a download cache. The downloaded data in the cache has to be decompressed, and this decompression has to be performed prior to display, because there is a great deal of data to be processed. The display is not decompressed. Dithering may be performed on the player.

The amount of data per frame is 1920×1080×4, which is about 8 MB (megabytes), where the ‘4’ bytes derives from 30 bpp colour depth. At 60 fps, this is about 480 MB per second, or about ½ a gigabyte (GB) per group of 64 frames, where 64 frames can be the number of frames from one key frame to the next key frame. We tend to store frames in groups or chunks of 64 frames, hence this is a relevant calculation of memory size for us.

In an example, we use a codec including a compressed format structure, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy. For example, the lowest level (level zero) of the hierarchy are key frames. In the next level, (level one) there are delta frames, which are the deltas between the key frames. In the next level (level two) there are delta frames, which are the deltas between the level one frames. In the next level (level three) there are delta frames, which are the deltas between the level two frames, etc. The compressed data comprises key frames and deltas, in which the deltas have a chain of dependency back to the key frames.

So for example, in a system with 63 frames between key frames, where 63=2\hat{ }6−1, the hierarchy has levels from level zero to level six.

In an example, a frame at a particular level includes a backwards-and-forwards flag, which, if set, indicates that the next frame at that particular level is identical to the current frame, hence image data for the next frame at that particular level need not be present in the stored frames, and image data for higher level frames (of higher temporal resolution) between the frame at the particular level and the next frame at that particular level need not be present in the stored frames. For frames which need not be present in the stored frames, no data needs to be provided in the bitstream, when a representation of the video is being transmitted.

In an example, a frame at a particular level includes an (e.g. linear) interpolation backwards-and-forwards flag, which, if set, indicates that the next frame at that particular level can be obtained by (e.g. linearly) interpolating between the current frame and the next-next frame at that particular level, hence image data for the next frame at that particular level need not be present in the stored frames, and image data for higher level frames (of higher temporal resolution) between the frame at the particular level and the next-next frame at that particular level need not be present in the stored frames. For frames which need not be present in the stored frames, no data needs to be provided in the bitstream, when a representation of the video is being transmitted.

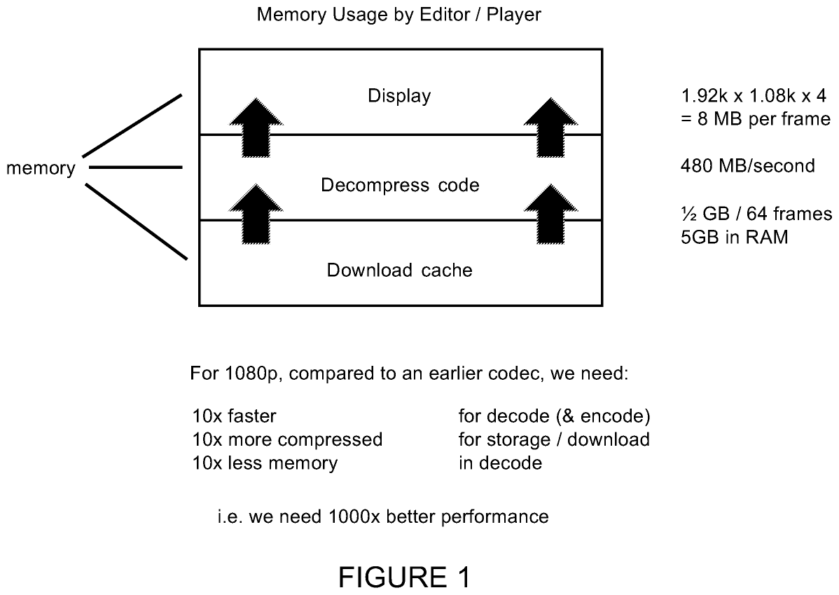

So the ½ GB per group of 64 frames needs to be stored in the display cache. Javascript running in a browser has memory limits, which typically only allows 2 GB maximum, and some smartphones allow less than this. The memory limit has to include the editor, all the caches, and anything else. So the display cache may be limited to 1 GB. There is latency, because you are downloading from the internet. In practice, we need to be able to decode multiple blocks of 64 frames, where 64 frames is about ½ GB. If you were processing multiple blocks in parallel, then you might need 5 GB of RAM. In Blackbird 9, because the data rate was about 10 times lower, we only needed about 5/10=½ GB of RAM, so there was no problem. With the new video codec, we have a problem, because we want it to run in Javascript, and it appears this is going to be a problem, because 5 GB is greater than 1 GB to 2 GB. An example of memory usage by the editor/player is shown in FIG. 1.

So in the new video codec, ideally we need the decode (and the encode) process to run ten times faster than in Blackbird 9, ideally we need to compress ten times more for storage and download (because the data rate at which the video is transmitted and received should not change), so that the 5 GB we mentioned will fit in about ½ GB, and ideally we need to use ten times less memory in decode, to permit caching. This could be characterized as requiring a 10×10×10=1000 times performance improvement over Blackbird 9. We can't process the video stream on a per pixel basis e.g. for running in javascript, because we can't expect that the processor speed on a typical consumer device will be fast enough to decode compressed video, or that there will be enough memory available in a web browser environment.

Here are examples of approaches which may be used to obtain the performance objectives of the new video codec.

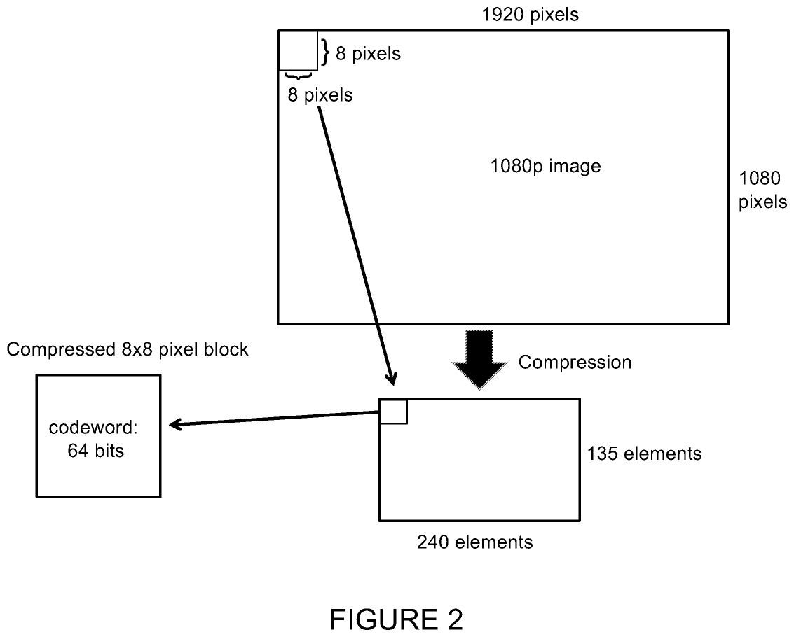

A 1920×1080 image is stored in a 240×135 array, which has about 32,000 entries, in 8×8 compressed pixel blocks, where each 8×8 compressed pixel block is represented by a codeword of 64 bits. Each compressed pixel block is formatted to be decompressed very rapidly. One advantage of using the 8×8 compressed pixel blocks is that 10-20 times less memory is being used, on average. Because each 8×8 compressed pixel block is represented by a codeword of 64 bits, this is one bit per pixel, on average. The intention is that receiving and expanding the 8×8 compressed pixel block will take less time than receiving and expanding a comparable fraction of an image in the Blackbird 9 codec, which is aimed at 360 p class images. The compression here is lossy compression. An example is shown in FIG. 2.

When playing back, the image is expanded and shown on the screen, so it is easy to play back video.

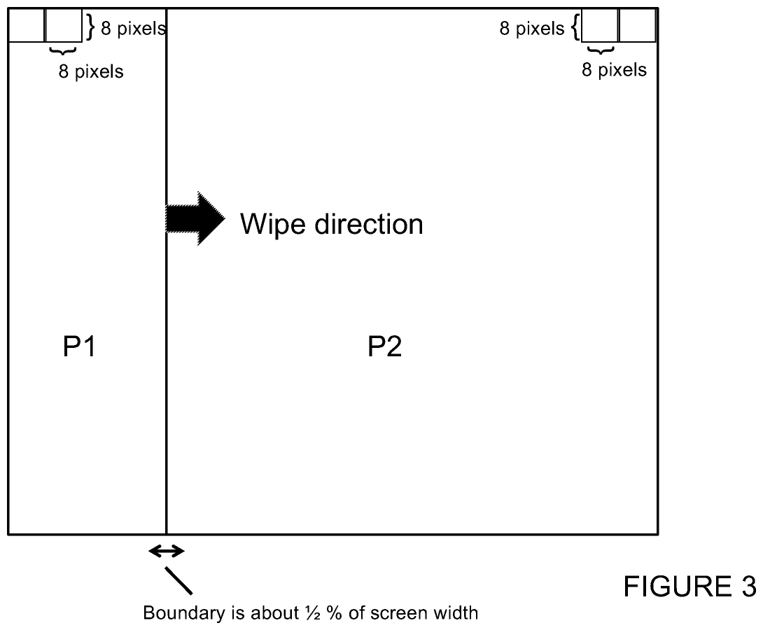

Consider the case of a wipe video effect, in which one video slides in from one side of the screen, and replaces another video that was playing on the screen. Consider a linear function f, for which f(x)+f(y)=f(x+y). This means you can add x and y, and then perform the function f, or you can perform the function f on each of x and y, and then add f(x) and f(y), and the final result is the same. So here to perform the video wipe effect, the image on the left P1 can slide across the screen, replacing image P2 on the screen. The compressed images in pixel blocks can be used to pre-assemble the screen, and then the compressed images in the pre-assembled screen can be decompressed, to provide the screen to be seen by a viewer. There are 240 pixel blocks across the screen, so using only steps of whole pixel blocks, the slide across the screen can be implemented in steps as low as 1/240 of the screen width which is about ½% of the screen width. If smaller steps are required, then special processing is needed for the boundary between P1 and P2, but this will only be for a portion of the screen which is a strip which is only 1/240 of the screen width which is about ½% of the screen width, which is a small proportion, and hence not too burdensome in terms of processing load. In this approach, the wipe is about 40 times faster than decompressing the pixels first and then performing the processing associated with the wipe, because the processing associated with the wipe is performed using a 240×135 compressed image, rather than with a 1920×1080 decompressed image. An example is shown in FIG. 3, which is for a horizontal wipe. Using the player/editor, the wipe can be performed in real time, using javascript.

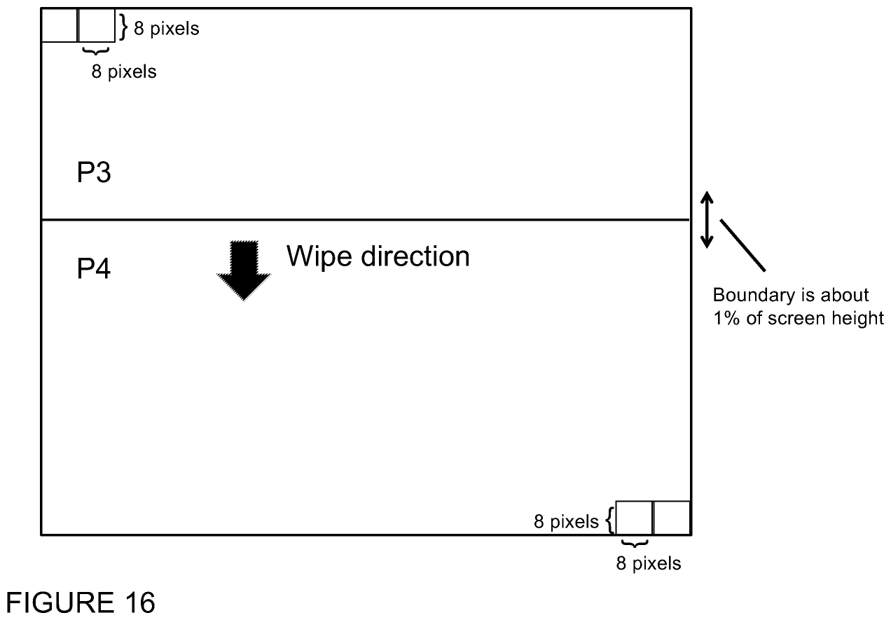

Consider the case of a wipe video effect, in which one video slides in from one side of the screen, and replaces another video that was playing on the screen. Consider a linear function f, for which f(x)+f(y)=f(x+y). This means you can add x and y, and then perform the function f, or you can perform the function f on each of x and y, and then add f(x) and f(y), and the final result is the same. So here to perform the video wipe effect, the image on the top P3 can slide across the screen, replacing image P4 on the screen. The compressed images in pixel blocks can be used to pre-assemble the screen, and then the compressed images in the pre-assembled screen can be decompressed, to provide the screen to be seen by a viewer. There are 135 pixel blocks vertically across the screen, so using only steps of whole pixel blocks, the slide across the screen can be implemented in steps as low as 1/135 of the screen height which is about 1% of the screen height. If smaller steps are required, then special processing is needed for the boundary between P3 and P4, but this will only be for a portion of the screen which is a strip which is only 1/135 of the screen height which is about 1% of the screen height, which is a small proportion, and hence not too burdensome in terms of processing load. In this approach, the wipe is about 40 times faster than decompressing the pixels first and then performing the processing associated with the wipe, because the processing associated with the wipe is performed using a 240×135 compressed image, rather than with a 1920×1080 decompressed image. An example is shown in FIG. 16, which is for a vertical wipe. Using the player/editor, the wipe can be performed in real time, using javascript.

Another effect to consider is the “dissolve” effect, which mixes two videos. The dissolve effect works by using a fade out of a first video, while increasing an intensity of a second video starting from zero intensity (or from a low intensity) to transition between the first video and the second video. This may also be called a cross-fade effect. In an example dissolve using two source videos, for every single pixel block, a weighted average of a frame from each of the two source videos is performed, the weighting depending on the relative contribution to the displayed frame desired from each of the two source videos.

For linearly-combinable pixel blocks, including uniform pixel blocks and bilinearly interpolated pixel blocks, for combination in a dissolve effect, the weighted average of the compressed images can be used, because the processing of linearly-combinable pixel blocks turns out to be linear, and this is much faster than using the decompressed images, because the associated processing is performed using two 240×135 compressed images, rather than using two 1920×1080 decompressed images. For 1080p images, it turns out that much of these images comprise linearly-combinable pixel blocks. For linearly-combinable pixel blocks, the combined codeword is the codeword of the combined pixels. In this approach, the computation for the dissolve effect is about 40 times faster than the computation for the dissolve effect performed using decompressed images, because the processing associated with the dissolve effect for linearly-combinable pixel blocks is performed using two 240×135 compressed images, rather than using two 1920×1080 decompressed images.

Using the player/editor, the dissolve effect can be performed in real time, using javascript.

Where the 8×8 pixel blocks are uniform, or bilinearly interpolated, one can perform a cross fade from the first 8×8 pixel block to the second 8×8 pixel block by using a linear fade on the YUV values from the first block YUV values to the second block YUV values. This is 64 times faster than performing the processing on a per pixel basis. This process also works if either the first block or the second block contains one edge, and the other block is uniform or bilinearly interpolated. This process also works if the first block contains one edge, and the second block contains one edge. Here typically the rendering is done on the display (e.g. the display thread), so there is no intermediate storage involved. In an example, rendering is performed on the display, so there is no storage of images intermediate to the two source images, and the displayed cross-faded image.

### Example Block Structure

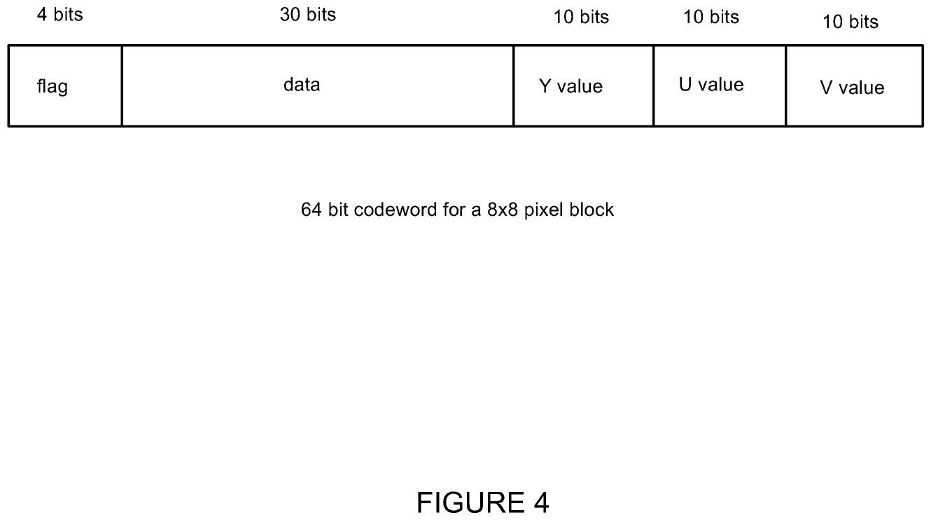

In an example, a 64 bit codeword is used for an 8×8 pixel block. In this example, the top 4 bits contain a flag. The next 30 bits are data. The last 30 bits are three groups of ten bits to represent colour, e.g. ten bits each for the Y value, the U value and the V value, or ten bits each for the R value, the G value and the B value. One or more bits in the 30 data bits may be used as an extension pointer, which points to extension block(s) which include extra data, for use with specific flag values, which correspond to 8×8 pixel blocks including image data that is too complex to represent accurately in the standard 64 bit codeword. An extension block is typically a 64 bit word. An example of a 64 bit codeword for an 8×8 pixel block is shown in FIG. 4.

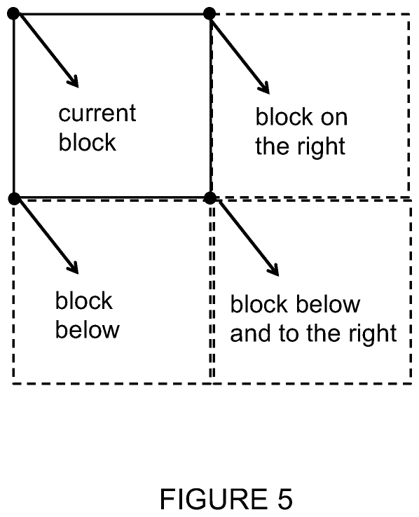

The 64 bit word can be thought of as an instruction of how to make the 8×8 pixel block.

Where the flag is 0000, this corresponds to a uniform block, with a colour given by the 30 bits that represent colour, e.g. YUV Values, or RGB values. Here the data part is zero, because there is no data, because it is a uniform block.

Where the flag is 0001, this corresponds to a bilinear interpolation. You might think that we need four colour values to perform a bilinear interpolation, one for each corner. This is true, but we only need one colour value to be represented in the current block, because we can get the other three colour values from neighbouring blocks. An example is shown in FIG. 5, in which the colour for the top left corner is contained in the current block; the colour for the top right corner comes from the block on the right; the colour for the bottom left corner comes from the block below, and the colour for the bottom right corner comes from the block below and to the right. This allows the bilinear interpolation to be performed for the current block, which is the block on the upper left. Here the data part of the 64 bit codeword is zero, because there is no data, because it is a bilinearly interpolated block.

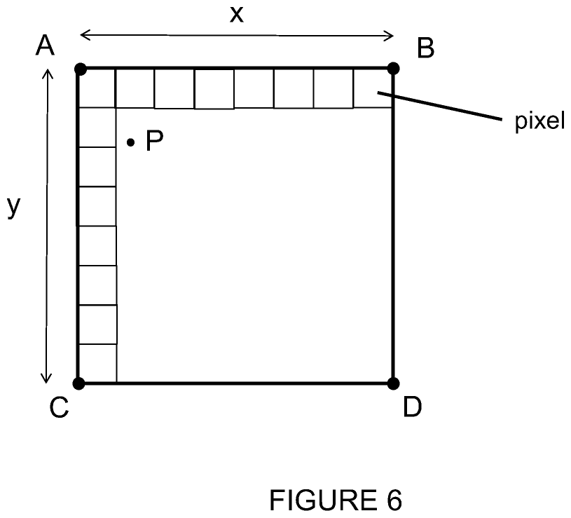

In mathematics, bilinear interpolation is a method for interpolating functions of two variables (e.g., x and y) using repeated linear interpolation. Bilinear interpolation is performed using linear interpolation first in one direction x, and then again in the other direction y. For bilinear interpolation over a square area with four corners, where initially the signal strength is known only at each of the four corners A, B, C, D, the signal strength at a given point P is most influenced by the signal strength at the corner closest to the given point, and is second most influenced by the signal strength at the corner second closest to the given point, and is third most influenced by the signal strength at the corner third closest to the given point, and is least influenced by the signal strength at the corner furthest from the given point. An example is shown in FIG. 6. Bilinear interpolation is computationally fast, because it is a linear approach, and computers can perform linear calculations quickly, faster than multiplication or division. For example, in bilinear interpolation, the difference, per pixel, as you go from left to right is a first constant value, and the difference, per pixel as we go from top to bottom is a second constant value. So we can perform the bilinear interpolation as we move left to right by adding the first constant value. And we can perform the bilinear interpolation as we move top to bottom by adding the second constant value. Computer processors perform addition operations very quickly. For example for some processor chips we can perform four add operations in one clock cycle. In an example, a processor chip can perform eight add operations in one clock cycle. Therefore a bilinearly interpolated 8×8 pixel block can be computed and displayed very quickly, and using relatively little processing power. This has an environmental benefit, because using relatively little processing power saves energy, which is environmentally beneficial.

In a 1080 p image example, a large fraction of the blocks are expected to be uniform (flag is 0000) or to use bilinear interpolation (flag is 0001).

A bilinearly interpolated 8×8 pixel block may include dithering, or may be assembled using dithering. The dithering patterns may be stored in lookup tables (LUTs), for application in an 8×8 pixel block. The dither lookup tables may be stored in a cache, to provide high speed processing. In an example, the dither lookup tables may be stored in a cache in a processing chip (e.g. CPU), to provide high speed processing. In an example, the dither lookup tables may be stored in a level 1 (L1) cache in a processing chip (e.g. CPU), to provide high speed processing. Dither lookup tables may include lookup tables for soft edges. Dither lookup tables may include lookup tables for hard edges. Dither lookup tables may include lookup tables for soft edges and for hard edges. Using dithering and LUTs is a fast way of providing 8×8 pixel blocks when providing bilinearly interpolated blocks, because we do not need to perform the bilinear interpolation calculations. Instead we use dithering and LUTs, to provide 8×8 pixel blocks which are as acceptable to the human visual system, as providing bilinearly interpolated 8×8 pixel blocks.

If for each edge type, for each of the 8×8-64 pixels, a dither value is stored using three bits then the amount of memory required to store all the dither values in lookup tables for all the eg. 512 edge types is, in bytes, 3*64*512/8=12 kbytes. 12 kbytes, is smaller than an (e.g. L1) CPU cache size of 32 kbytes, hence these values can be stored in the (e.g. L1) CPU cache and used from the (e.g. L1) CPU cache, to speed up processing. In an example, the L1 is cache is fast, because it takes only one clock cycle to retrieve data from the L1 cache.

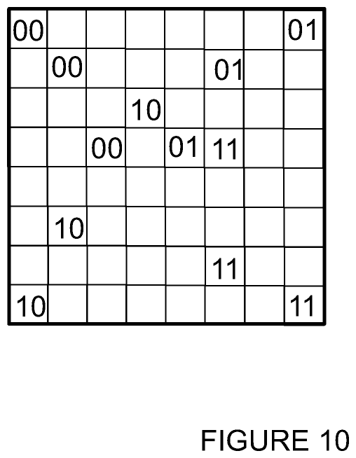

Performing a full bilinear interpolation across an entire 8×8 pixel block can still be computationally slow. Instead we can use a lookup table which tells you which of the four corner colours to insert for a given pixel. An example of a lookup table is shown in FIG. 10. Since you are selecting one of four colours, for each pixel, you need two bits per pixel, hence 2×8×8=128 bits, which is 16 bytes, to encode the lookup table for the whole 8×8 pixel block. Then for example for the case of 8×8 pixel blocks which include an edge, (e.g. flag is 0010), you have a lookup table for each type of edge, hence for each of the 514 cases identified later on in this disclosure, in an example, so that appropriate dithering can be applied for each type of edge, in a computationally efficient manner. If each lookup table requires 16 bytes, and there are about 1000 types of edges for 8×8 pixel blocks, including soft and hard edges, then the lookup tables for soft and hard edges for the 8×8 pixel blocks require about 16 kbytes. These 16 kbytes can be stored in the L1 cache so as to speed up processing, e.g. image decompression processing, when using the lookup tables.

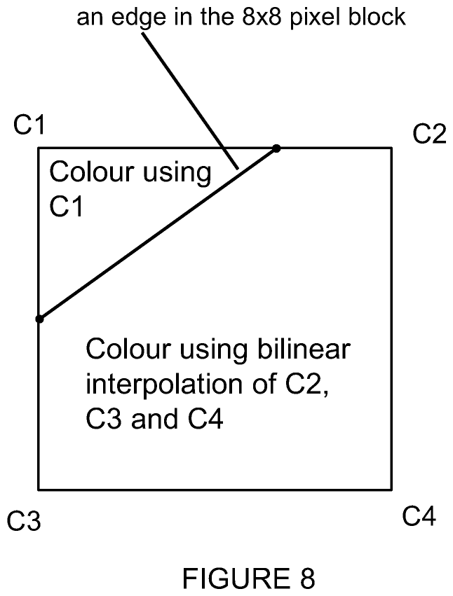

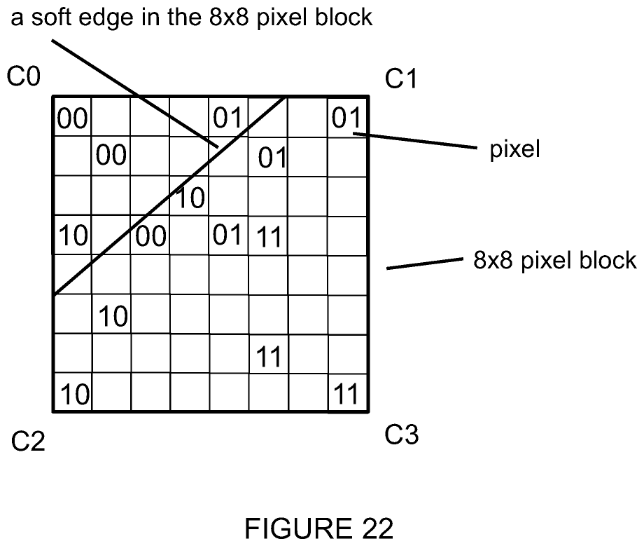

In the case of a soft edge, for an 8×8 pixel block which is coloured-in using dithering using a lookup table, in contrast to the situation shown in FIG. 8, some pixels in the part of the 8×8 pixel block for the corner closest to the edge are coloured in using not the colour of the corner closest to the edge, but using colours from the other corners. An example of a lookup table for such a soft edge, overlaid on the 8×8 pixel block including a soft edge, is shown in FIG. 22. Similarly, a lookup table can be used for colouring-in an 8×8 pixel block including a line.

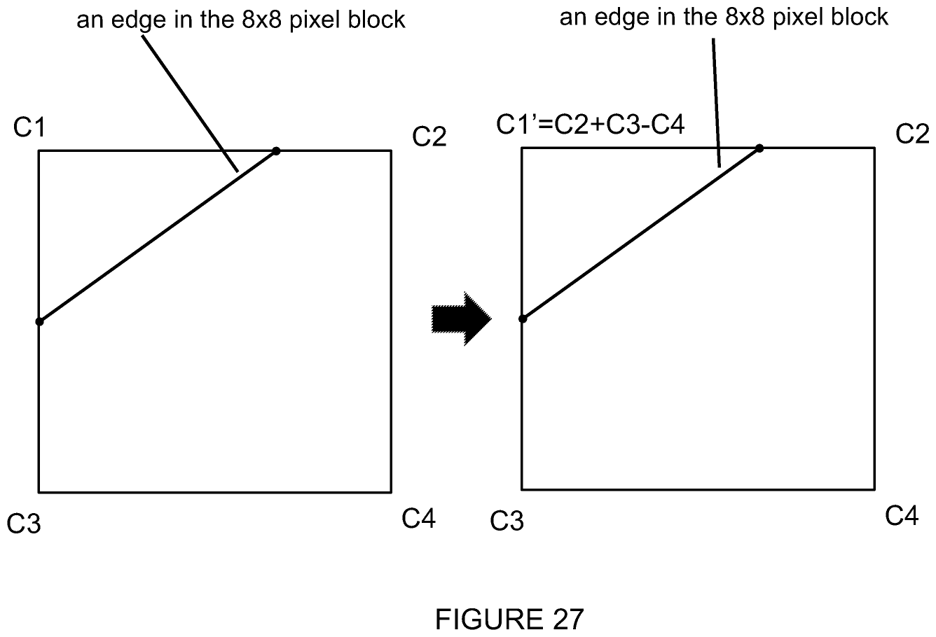

An improved method of colouring-in an 8×8 pixel block, which includes one corner which is on the opposite side of an edge to the other three corners, and which is coloured-in using dithering using a lookup table, is to use a fake colour value C1′ for the corner which is on the opposite side of an edge to the other three corners, when colouring in the region that is on the side of the edge of the three corners. The sums of the colour values of opposite corners are taken to be equal, hence C1′+C4=C2+C3. Hence C1′=C2+C3−C4, and because C1′ can be derived from arithmetic operations using C2, C3 and C4, C1′ does not need to be stored. When colouring-in the 8×8 pixel block, when colouring in the region that is on the side of the edge of the three corners, using a look-up table we can dither the colours C1′, C2, C3 and C4, to obtain an improved colouring in compared to using only the known corner colour values C2, C3 and C4; C1 itself is not used in this task because it is likely to be completely unsuitable, because the C1 corner is on the opposite side of the edge to the region which is being coloured-in. An example is shown in FIG. 27, in which instead of using only the known corner colour values C2, C3 and C4 to colour-in the region on the opposite side of the edge to the corner with colour C1 (FIG. 27 left hand side), the colours C1′, C2, C3 and C4, can be dithered to obtain an improved colouring-in for the region on the opposite side of the edge to the corner with colour C1 (FIG. 27 right hand side).

A fake corner colour can be signified by using a further bit, so if Oxy in binary denotes the four corner colours, 1xy denotes the four fake corner colours, e.g. 000 is C1 and 100 is C1′. Hence the corner colours may be denoted using three bits, for example in a lookup table.

However, a problem can arise with the approach exemplified in FIG. 27. To explain the problem, we consider a simplified example. Consider a colour scale which ranges from zero for black, to 255 for white. Now consider the case in C2 is 10, C3 is 10 and C4 is 41. C1′ is then 10+10−41=−21, which is out of range, and which is 235 if we use modulo 255, hence three colours which are nearly black have given rise to a fake colour which is nearly white. The skilled person will appreciate that if this approach is not modified, this approach will give rise to image artefacts. What to do? If we try to include code to correct this out-of-range problem on the decoder, this will slow down image provision, which is very undesirable. Hence we may correct this problem by processing at the encoder. In an example, at the encoder, if an out-of range fake colour results from using C1′=C2+C3−C4, we adjust the values of C2, C3 and C4 such that an out-of range fake colour does not result from using C1′=C2+C3−C4. By correcting the problem at the encoder, the decoder can be kept simple, and therefore the decoder can execute swiftly, while preventing image artefacts. An alternative is not to use a fake C1, i.e. not use C1′, and accept there will sometimes be some colouring artefacts. An alternative is to use a different fake C1, e.g. use C1′=(C2+C3)/2, and accept there will sometimes be some colouring artefacts. Or we can make the compressor only output cases in which there is no out of range problem, and hence a different representation to the single edge representation of the 8×8 pixel block should be used.

A typical video frame will not include all the about 1000 types of 8×8 pixel blocks including an edge. So the L1 cache does not need to include the lookup tables of the types of 8×8 pixel blocks including an edge for the types of 8×8 pixel blocks including an edge which are not included in the video frame. So in an example, the L1 cache includes only the lookup tables of the types of 8×8 pixel blocks including an edge which are included in the video frame. In an example, the L1 cache includes the lookup tables of the types of 8×8 pixel blocks including an edge which are included in the video frame, and does not include some or all of the lookup tables of the types of 8×8 pixel blocks including an edge for the types of 8×8 pixel blocks including an edge which are not included in the video frame. This helps to use the L1 cache more efficiently, which allows the L1 cache to be used for other processes, which can speed up processing, such as video frame decompression processing.

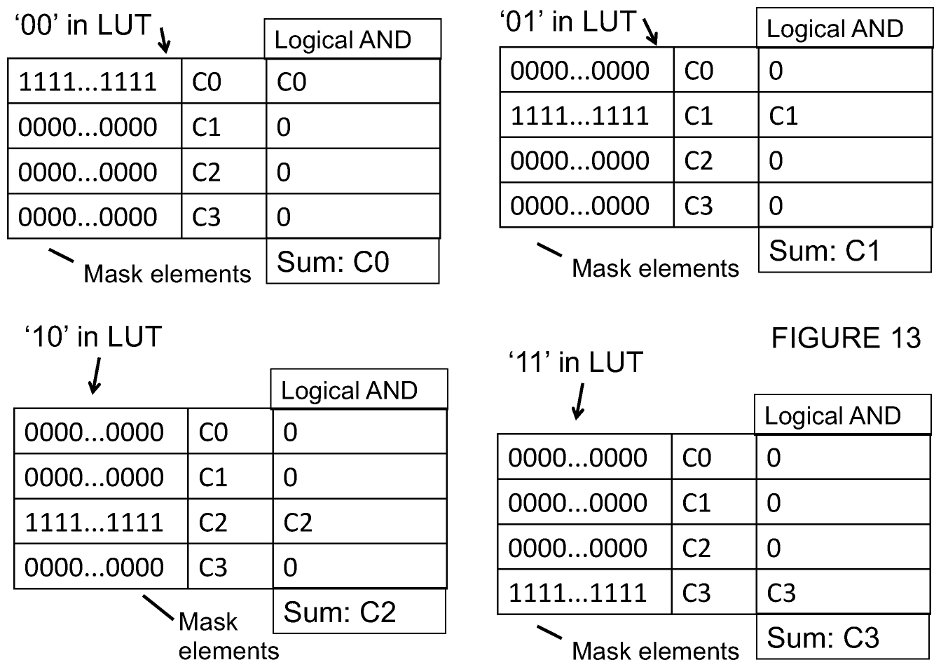

In an example, for each of the four values of the lookup table, a set of four binary mask elements is defined, each being all ones or all zeros. These four mask elements are then used in a logical AND operation with the four corner colours C0, C1, C2 and C3, and the results are summed, to give a single colour for each value of the lookup table. Examples of the operations are shown in FIG. 13. The resulting colour value, which is one of C0, C1, C2 and C3, can then be inserted into the pixel of the 8×8 pixel block. This has the advantage that (e.g. only) logic operations are used, and for example IF. . . . THEN structures, or equivalents, are not used, because they are computationally less efficient. This means that, in this respect, no pipeline is being used, because (e.g. only) lookup tables and logic operations are being used. There is no misprediction in the pipeline, e.g. an IF statement that is examined and not satisfied. This provides very fast processing. This approach is particularly well suited to use in javascript, because javascript works relatively slowly, and javascript has a limited instruction set.

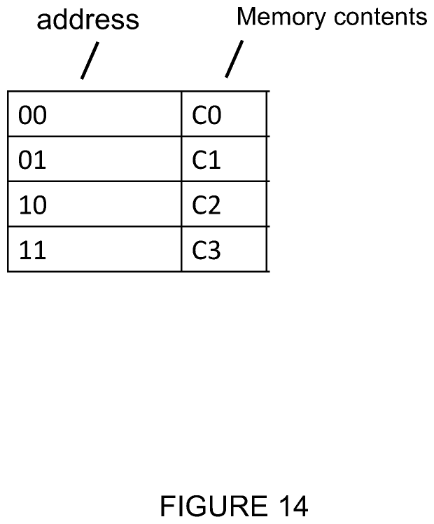

In another approach, we can load the four corner colours C0, C1, C2 and C3 into consecutive memory addresses, as shown for example in FIG. 14. Then one can load the required pixel colour based on the corresponding two bit address, taken from a lookup table value, using a command such as LDR result, [2 bit offset], as would be understood by one skilled in the art. Example pseudocode which could be used is as follows. This is per 64 pixels. The approach may be summarized as using (e.g. only) lookup tables and logic operations.

STORE C0, Memory0
STORE C1, Memory1
STORE C2, Memory2
STORE C3, Memory3

This is four instructions for 64 pixels. So this is 1/16 of an instruction, per pixel. The example pseudocode continues

MOV R0, row0 >>0
AND R0, R0, #3
LD32 pixel0, Memory [R0]
MOV R1, row0 >>2
AND R1, R1, #3
LD32 pixel1, Memory [R1]
ADD64 pixels, pixel0 +(pixel1 <<32)
STORE64 pixels, [image], #64

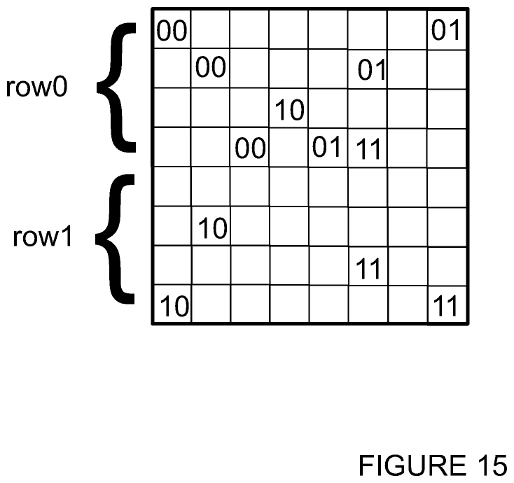

The eight lines of pseudocode immediately above can be carried out in two processor clock cycles, for two pixels. Logical AND with ‘3’ collects the two lowest bits. These two lowest bits are used as an offset, to load the required colour out of C0, C1, C2 and C3. LD32 is a 32 bit load. The rows row0 and row1 of the lookup table are shown in the example of FIG. 15.

On some chips, e.g. an Intel chip, we can perform two loads and one store in one cycle. And we can also perform four instructions per cycle, depending on the instructions. So we can perform the AND and the MOV, and the ADD and the AND and the MOV in one cycle. Hence the eight lines of pseudocode immediately above can be carried out in two processor clock cycles, for two pixels.

So if you have an e.g. Intel processor running at 2.5 GHZ, which is not the fastest available processor, you can process 2.5 billion pixels per second. But we need to display about 120 million pixels per second. So dithering and display is only using about 5% of the CPU capacity.

However, it is desirable to increase the speed of image processing even further. To do so, we can incorporate the LUTs into the computer code. We set up

R0=C0
R1=C1
R2=C2
R3=C3

Where the ‘R’ are registers and the ‘C’ are colours of the four corners of an 8×8 pixel block. In an example, the executable code may be

ST32 R0, [image]
ST32 R0, [image+1]
ST32 R1, [image+2]
ST32 R2, [image+3]
. . .
ST32 R3, [image+63]

This is using a LUT which has been incorporated into the computer code. An example processor (e.g. Intel) can perform two stores per clock cycle. So now we are processing the image at ½ a cycle per pixel. So now no looking-up is performed: the code executes to perform the same image processing outcome as would have been achieved using a lookup table, but the processing is faster.

However, we can speed up the image processing even further. An example is the following pseudo code

ADD64 R4, R0, R0 << 32
ST64 R4, [image]
ADD64 R4, R1, R2 << 32
ST64 R4, [image+2]

Because 64-bit stores are being used, each 64-bit store stores two pixels. These four instructions can be carried out in one cycle, to write out four pixels. So now we are processing the image at ¼ a cycle per pixel. So a 5 GHz processor can process 20 billion pixels per second. We need to process 120 million pixels per second to provide high definition (HD) display with dither. Hence we have a processing speed which is 20000/120, or about 160 times faster than needed to provide HD display with dither. This process only works for flag=0000 or 0001, so for uniform blocks or for bilinearly interpolated blocks with dither (for uniform blocks we don't need to use this process, because the four corner colours are the same), so not for blocks including edges, and not for blocks including texture. But typically about 90% of 8×8 pixel blocks are uniform blocks or bilinearly interpolated blocks with dither, so the overall process is fast.

Writing similar code to the preceding example for use with edges may not work in the same way, because the total code for all the possible types of edges would not, or may not, fit in the cache.

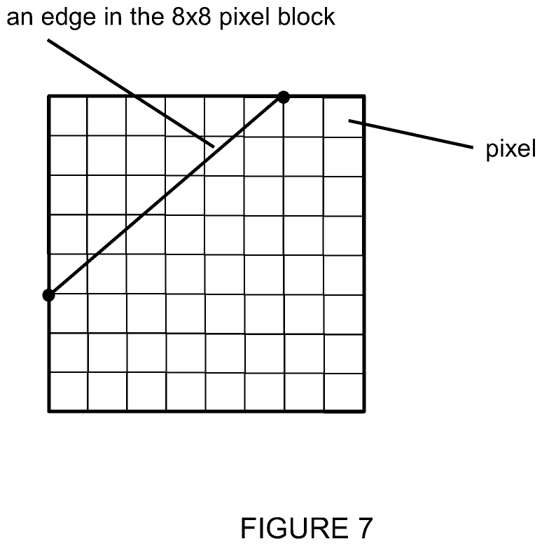

This approach may run in javascript, but it does not need to run in javascript. For example, we may write an app for a smartphone than runs on the smartphone.

Where the flag is 0010, this corresponds to a pixel block including an image of an edge. An edge is a straight line from a pixel on one side of the pixel block, to another pixel on another side of the pixel block. An example is shown in FIG. 7. Such an edge image can be represented using 10 bits of data. To show that 10 bits of data is about right, we provide the following plausibility argument, which might not be mathematically rigorous. Consider a line starting on the left hand side of the pixel block, and terminating on another side of the pixel block. The starting position can be selected in nine ways. The end position can be selected in 8+8+7=23 ways, as we go around the other sides. Hence there are 9*23=207 ways in which this line can be selected. However, the line could have been selected to start from any one of the four sides, so we need to multiply the result by four. But this overcounts the number of lines by a factor of two, because a line from E to F is also a line from F to E. So the number of possible lines is 207*4/2=514. 514 is a number which can be represented using 10 bits.

Another way to calculate the possible number of edges in an 8×8 pixel block is the starting point can be selected in 32 ways, and the end point can be selected in 31 ways, and we divide by two because an edge from point E to point F is an edge from point F to point E, hence there are 32*31/2=496 possible edge types, which can be represented using 9 bits. So the edge types in a pixel block can be represented using as a few as 9 bits.

For a 8×8 pixel block including an edge, how do we get from the lookup table to the final 8×8 pixel block, in a computationally efficient manner? In an example, we use logical AND operations, and addition operations.

For colouring in parts of an edge image in a pixel block, if the part of the edge image contains only one corner, then the specified colour is provided uniformly for the part of the edge image including that one corner. If the part of the edge image contains two corners, then linear interpolation is used to colour in the part of the edge image including the two corners, based on the colours associated with the respective corners, from the pixel block itself, or from adjacent pixel blocks. If the part of the edge image contains three corners, then bilinear interpolation is used to colour in the part of the edge image including the three corners, based on the colours associated with the respective corners, from the pixel block itself, or from adjacent pixel blocks. An example of an 8×8 pixel block including an image of an edge is shown in FIG. 8, in which the corners have respective colours C1, C2, C3 and C4, in which the area between the edge and the corner with colour C1 is coloured C1, and in which the rest of the area of the 8×8 pixel block is coloured using bilinear interpolation between the colours C2, C3 and C4.

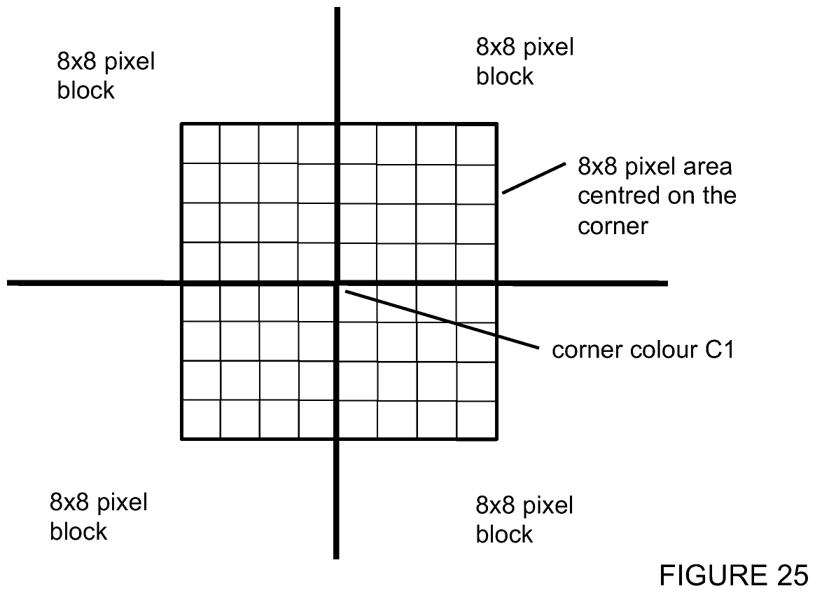

For determining the colour at a corner of a pixel block, in a region where there are no abrupt changes in colour, e.g. there are no edges, the colour can be determined by averaging the colours in an 8×8 pixel area centred on the corner. An example is shown in FIG. 25.

If the part of the edge image of an 8×8 pixel block contains only one corner, then the specified colour of the one corner needs to be selected carefully, as the colours of the other three corners C2, C3 and C4 could be very different. For example taking the average of the colours of the pixels in the 8×8 pixel block may lead to a very inaccurate value for the colour C1 of the one corner. In an example, the selected colour C1 may be chosen by averaging pixels including using some pixels in neighbouring 8×8 pixel blocks, to obtain an accurate colour value for the one corner.

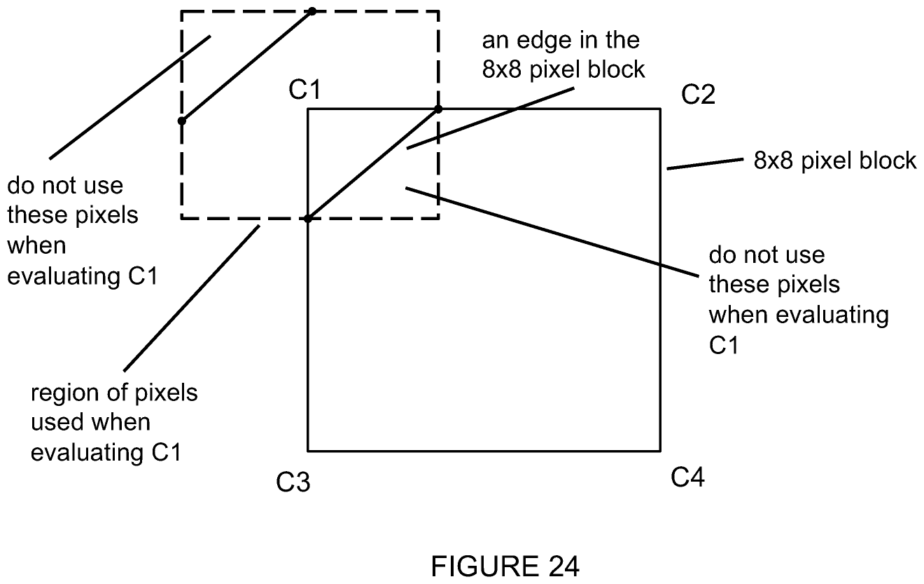

But to make the averaging unbiased, an area of pixels outside the 8×8 pixel block may be excluded from the averaging process which is symmetric, relative to the one corner, with the area of pixels in the 8×8 pixel block which is on the opposite side of the edge to the corner with colour C1. By making the averaging unbiased, this avoids colour artefacts in the image constructed using the codewords. In the example of FIG. 24, the colour C1 for a corresponding corner is evaluated by averaging pixels inside the dashed shape, which includes some pixels in neighbouring 8×8 pixel blocks (neighbouring pixel blocks not shown), so as not to use pixels in the 8×8 pixel block which are on the opposite side of the edge compared to the corner with colour value C1, and so as not to use pixels outside the 8×8 block which are symmetric, relative to the corner with colour value C1, with the area of pixels in the 8×8 pixel block which is on the opposite side of the edge to the corner with colour C1.

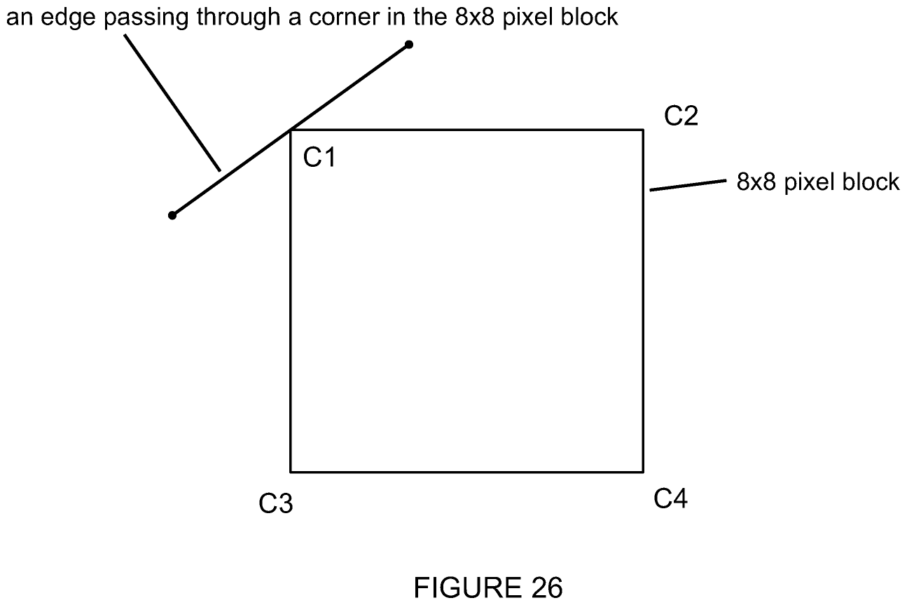

A special case for evaluating a corner colour is when an edge passes directly through a corner. In this case, the colour C1 for the corner through which the edge passes is evaluated using the colours of the other three corners C2, C3 and C4 though which the edge does not pass, because the colour for the corner through which the edge passes will not be obtained accurately if we average the colours in an 8×8 pixel area centred on the corner through which the edge passes, and because C2, C3 and C4 are all on the same side of the edge. In an example, the colour C1 for the corner through which the edge passes is evaluated using bilinear extrapolation of the colours C2, C3, C4. An example is shown in FIG. 26, in which the colour C1 for the corner through which the edge passes is evaluated using the colours of the other three corners C2, C3, C4 though which the edge does not pass, e.g. using bilinear extrapolation. An edge type identifier can be given for a 8×8 pixel block in which an edge passes directly through a corner; this differs from the possible 496 edge types discussed above, but the number of possible instances of 8×8 pixel blocks in which at least one edge passes directly through at least one corner is limited (for example to a yes/no for each of the four corners, hence to 2\hat{ }4=16 types), so that the number of edge types still does not exceed 512, and hence can still be represented using 9 bits. In an example, block corner colours only use pixel colours which are on the same side of an edge.

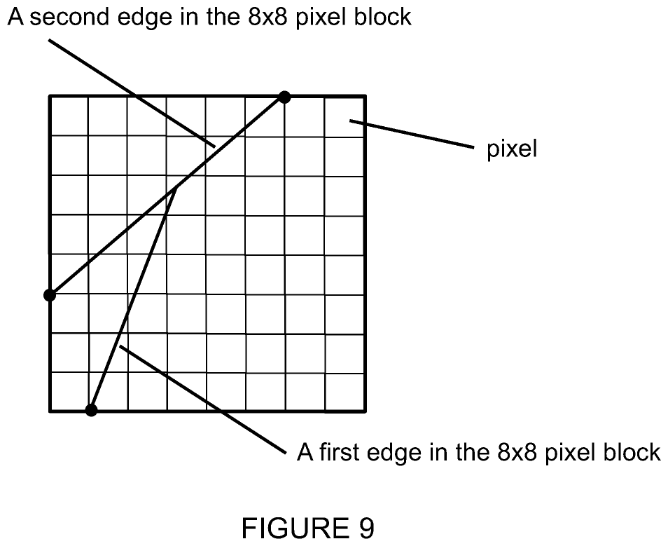

Sometimes there are two edges in an image, which may intersect. To represent two edges in an image, we need 20 bits of data, because roughly speaking 10 bits of data are needed to represent an edge, and 2*10−20. In an example, for two edges in an image, we use a flag value of 0110. The second edge is placed on top of the first edge, to provide that part of the first edge in isolation may be blocked out by the second edge. The two edges don't have to be at right angles to each other, they can be at any angle to each other. An example is shown in FIG. 9.

In an example, we use a flag of 0011 to represent an 8×8 pixel block which includes one line. Either side of the line, the pixels may be bilinearly interpolated. An example in an image could be a wire, which appears as a thin line, with the same or a similar colour on either sides of the line. For example, the background can be bilinearly interpolated, using the colour values of the four corners, and the line is on top of the background, in a different colour to the background, in which the different colour may be darker or lighter than the background.

Where an edge or a line continues from one 8×8 pixel block to the next 8×8 pixel block, we need only store one end of the line with respect to an individual 8×8 pixel block, as the next point on the line is defined with respect to the adjacent 8×8 pixel block. This approach helps to reduce artefacts, as there is no break in the line at the edge of the 8×8 pixel block, in this example. This approach also reduces the data stored, because we only store one end of the line with respect to an individual 8×8 pixel block.

Where the flag is 0100, this corresponds to texturing two YUV values, or to texturing two RGB values. The 30 bit data contains the offset to the YUV or RGB value encoded in the last 30 bits of the 64 bit codeword. A contrast may be encoded in extra data (e.g. +/−8 grey scales), and an offset to the mask may be encoded in extra data, in which case data additional to the 64 bit codeword is required to store all the information. In an example, the two YUV or RGB values are determined from the original 8×8 pixel block data as follows. For the Y value, we find its highest and lowest values, and then determine the Y values that are 25% and 75% of the difference between the lowest and highest values, starting from the lowest value. We repeat this process for the U values, and the V values. The two YUV values for the two textures are then defined by the YUV values that are 25% of the difference between the minimum and maximum YUV values, starting from the minimum YUV values, and that are 75% of the difference between the minimum and maximum YUV values, starting from the minimum YUV values. This may be performed in a similar way for RGB values. Which of the two textures to use in each pixel of the 8×8 pixel block can be encoded with a ‘1’ or a zero for each pixel, hence using 8×8-64 bits.

Where the flag is 0101, this corresponds to texturing three YUV or RGB values. The main colour value is the YUV or RGB value encoded in the last 30 bits of the codeword. Then there is a plus offset to the YUV or RGB value, that is encoded in 30 bits, and a minus offset to the YUV or RGB value that is encoded in 30 bits. In this case, the codeword plus extension block(s) is at least 128 bits long, so it can include all the required data. This way, texturing three YUV values, or texturing three RGB values, in the 8×8 pixel block can be provided. Because there are three textures, you need two bits to represent which of the three textures corresponds to each pixel of the 8×8 pixel block, so this can be encoded using two bits for each pixel, hence using 8×8×2=128 bits. Three colour textures are useful for representing textures such as sand. In an example, the three YUV or RGB values are determined from the original 8×8 pixel block data as follows. For the Y value, find its highest and lowest values, and then determine the Y values that are 25%, 50% and 75% of the difference between the lowest and highest values, starting from the lowest value. We repeat this process for the U values, and the V values. The three YUV values for the three textures are then defined by the YUV values that are 25% of the difference between the minimum and maximum YUV values, starting from the minimum YUV values, that are 50% of the difference between the minimum and maximum YUV values, starting from the minimum YUV values, and that are 75% of the difference between the minimum and maximum YUV values, starting from the minimum YUV values. This may be performed in a similar way for RGB values.

More values of the 4 bit flag are provided, for various effects. When the flag is 1111, this provides raw pixels, for pixel blocks that are not suitable for compression, with e.g. 30 bits per pixel colour representation. In some cases, some 8×8 pixel blocks are not suitable for compression, and then these pixel blocks need to be stored using the flag 1111.

It appears that the above model is suitable for compressing 1080 p images by about a factor of 40, on average.

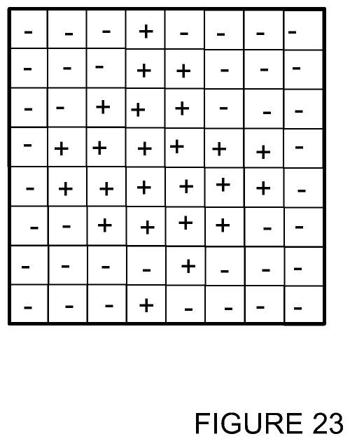

For a particular flag value, this is used for representing various, e.g. irregular, shapes in the 8×8 pixel block, and uses extra bits in addition to the standard 64 bit codeword for a 8×8 pixel block. In an example, there is an 8×8-64 bit mask (a “Y mask”) which stores if the Y values should be increased (plus) or decreased (minus) relative to the average Y value of the 8×8 pixel block. There is stored the increase in the Y value, where the Y value is increased. The negative of the stored increase in the Y value, may be used to decrease the Y value, where the Y value is decreased. Alternatively, there may be stored a decrease in the Y value, which is used to decrease the Y value, where the Y value is decreased. In the most general case, there are then stored in 20 bits the UV value (10 bits each for U and V), for use when the Y value is increased, and there are stored in a further 20 bits the UV value (10 bits each for U and V) for use when the Y value is decreased, leading to a total of 40 bits for the increased Y's UV value and for the decreased Y's UV value. An example of a 8×8=64 bit Y mask is shown in FIG. 23.

In practice the 64 bit mask and the total of 40 bits for the increased Y's UV value and for the decreased Y's UV value, which together are 64+40=104 bits, can usually be compressed, which reduces the number of bits required for an extension block to the standard 64 bit codeword for representing an 8×8 pixel block. In some cases, the compression can compress the data into the standard 64 bit codeword size, so that no extension block is required. For example, the UV values stored in the 40 bits are often quite similar to the UV value of the 8×8 pixel block, hence the UV values which may be stored in the 40 bits can be represented using less than 40 bits. This saves memory when storing a video image. This makes it easier to store images in device memory when processing video in a device with limited memory available when processing video, e.g. when running in javascript, such that reduced downloading of video images into the device memory is required.

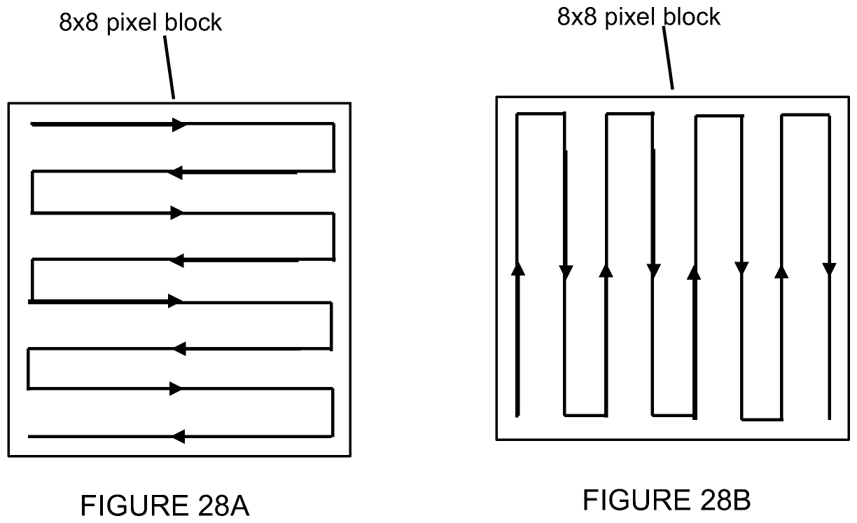

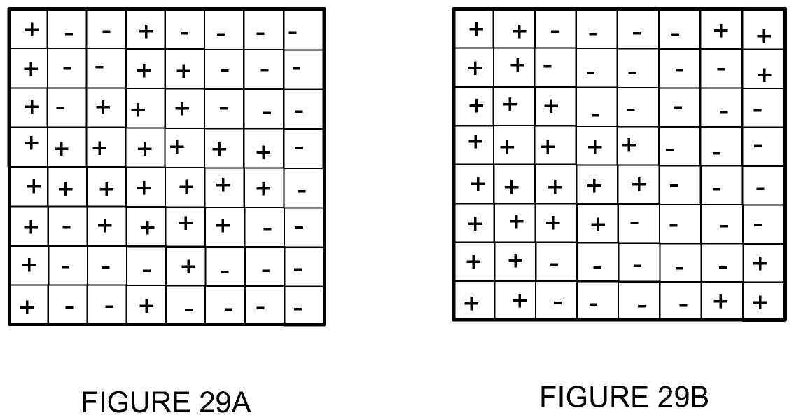

We have found that about 90% to 95% of the time it is possible to losslessly compress the Y mask and the associated UV values. We have found that the following is an efficient way of losslessly compressing the Y mask. Firstly, the path used across the 8×8 pixel block reverses when it meets the edge, in a snake path, where the snake path may be a horizontal snake path or a vertical snake path. An example of a horizontal snake path is shown in FIG. 28A. An example of a vertical snake path is shown in FIG. 28B. We use a form of run-length encoding. We have found that a snake path is better than for example a raster scan path, because the successive Y mask values have a stronger correlation as one turns a corner, as in a snake path, than if one goes back to the start of a row for the next row, as in a raster scan. For example, for the Y mask example of FIG. 29A, the successive Y mask values have a stronger correlation as one turns a corner, in a horizontal snake path, than if one goes back to the start of a row for the next row, as in a raster scan. We have also found that sometimes the run-length encoding works better if one uses a vertical snake path than if one uses a horizontal snake path, hence in an example, both options are provided. An advantage of this form of run-length encoding is that it is completely self-contained: it does not rely on compression knowledge obtained from elsewhere in the video. An advantage of this form of run-length encoding is that it is relatively fast.

In the example of FIG. 29B, starting from the top left, in a horizontal snake path, the sequence of pluses and minuses is: two pluses, four minuses, three pluses, five minuses, five pluses, eight minuses, ten pluses, seven minuses, six pluses, five minuses, three pluses, four minuses, two pluses. A possible form of run-length encoding is to encode the length using three bits, with 000 to 110 denoting a sequence of up to six of the same sign, with 111 denoting that the sequence is too long to be encoded in the three bits and carries on such that the next three bit value needs to be followed. We also need some header bits e.g. which encode whether the first pixel is a plus or a minus, and whether the snake path is horizontal or vertical, and a UV differ flag. Hence to encode the example of FIG. 29B, in an example the header would denote that the first pixel is a plus and snake path is horizontal, and then the run-length encoding would be, in decimal, 2, 4, 3, 5, 5, 7, 1 (=8), 7, 3 (=10), 7, 0 (=7), 6, 5, 3, 4, 2. For the first entry, it possible to use a slightly different encoding because the first entry cannot be zero length. Hence uniquely for the first entry, decimal zero to six can be used to represent a sequence of one to seven of the same sign. If we arrive at the end of the data for the Y mask, and there is a single final pixel which has not been specified, we assume that the sign changes for the single final pixel, and that the UV value is that for the 8×8 pixel block. This saves on data transmission relative to explicitly defining the properties of the single final pixel. In an example, the number of bits left for UV compression is 64 minus the number of bits you have used for other purposes.

The UV differ flag indicates whether or not the increased Y's UV value and the decreased Y's UV value are the same. An example is if the 8×8 pixel block is part of a uniformly coloured t-shirt, then the colour (UV values) is the same, but the Y values can differ, across the 8×8 pixel block. If the UV values are not the same, then the compressed structure stores the range of UV values, relative to the UV value of the 8×8 pixel block. However, the representation of the compression of the UV values has to fit in the available number of bits in the data structure after the Y mask values have been encoded. For example, the range of UV values relative to the UV value of the 8×8 pixel block may be from −2 to +2, i.e.−2,−1, 0, +1, +2, i.e. there are five values. Because 5\hat{ }4 is 625, this range can be stored using 10 bits, assuming there are 10 bits available for storage. For example, the range of UV values relative to the UV value of the 8×8 pixel block may be from −3 to +3, i.e.−3,−2,−1, 0, +1, +2, +3, i.e. there are seven values. Because 7\hat{ }2 is 49, this range can be stored using 6 bits, assuming there are 6 bits available for storage. In this example, 7\hat{ }4 is too big to store, so a corresponding number of bits to store up to 7\hat{ }4 is not used for storage. For example, the range of UV values relative to the UV value of the 8×8 pixel block may be from −15 to +15, i.e. there are 31 values. 31\hat{ }2 is 961. Therefore there are less than 1024 possibilities, and a ten bit compression format may be used. For example, the range of UV values relative to the UV value of the 8×8 pixel block may be from −1 to +1, i.e. −1, 0, +1, i.e. there are three values. Because 3\hat{ }4 is 81, this range can be stored using 7 bits, assuming there are 7 bits available for storage. If the range is from −1 to 0, or from 0 to +1, this is stored using a first bit to distinguish between these two possibilities, and there are four times one bit, about whether the change applies to each U and to each V value, hence these cases can be represented using five bits, which saves two bits compared to the case when the range is from −1 to +1, which requires seven bits. Although saving two bits seems small, over cached video data, this could add up to saving a megabyte of memory space in the cache. If the range is from −n to +n, we take a base of 2n+1. The algorithm works out what maximum UV range can be compressed, based on the available number of bits in the compression scheme. When you are decoding, you have to assume you are using the maximum range, because you have no information about what the range is. A lookup table may be used to obtain the maximum range from the number of bits available to encode the UV values in the encoding scheme. The same lookup table, or a related lookup table, may be used in the decoding scheme. In the encoding scheme and in the decoding scheme, the maximum range is used, even if the entire maximum range is not needed to encode or to decode the UV values.

The encoder knows how many bits are available to store the UV range relative to the UV value of the 8×8 pixel block, and the encoder converts that number of bits available to the maximum range available. The decoder has no information about the available range, so the decoder assumes the maximum range available from the number of available bits. A lookup table is used to determine the maximum range based on the number of bits available in the data structure after the Y mask values have been encoded. Here, the compression of the Y mask values and of the UV values is lossless.

If the encoder finds that the pattern in the 8×8 pixel block cannot be represented in this compressed structure, because there aren't enough bits in the compressed structure for successful encoding, the encoding routine returns a value (e.g. zero) indicating that encoding was not possible, and therefore a different approach to encoding, or no encoding, needs to be adopted. If in a first attempt, using a horizontal snake path, the encoder finds that the pattern in the 8×8 pixel block cannot be represented in this compressed structure, because there aren't enough bits, the encoder can try again, using a vertical snake path, to see if the pattern in the 8×8 pixel block can be represented in this compressed structure using the vertical snake path, and if successful, the pattern in the 8×8 pixel block is represented in this compressed structure using the vertical snake path.

The video may be stored using the packing. When I want to send the video, I may pack it, using the model, then I compress it, to send it in the bitstream. The packing is about trying to store in 64 bit words, to save memory when working on the video.

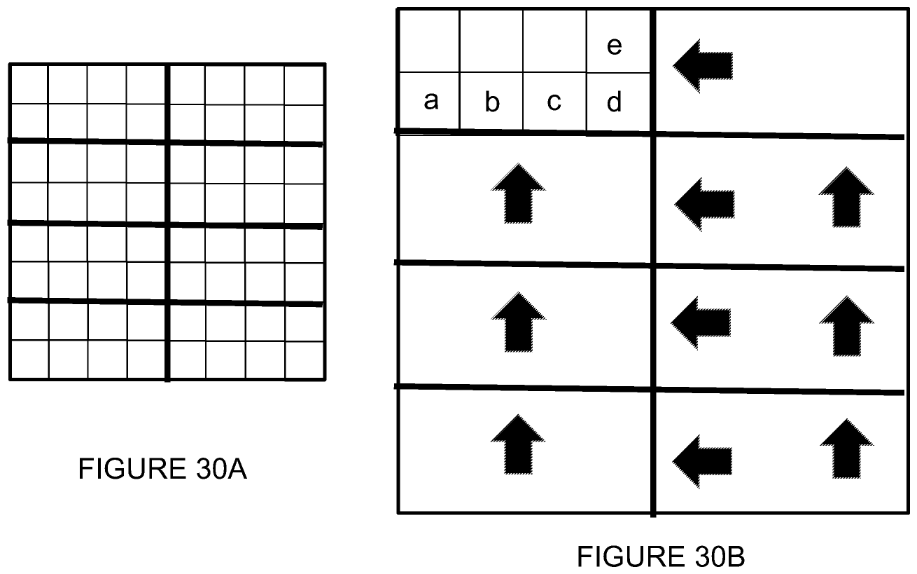

In the part of the compression, for the bitstream, we use transition tables, in which there is context, and there is data. How do we compress a Y mask? If you send the Y masks as whole blocks of 8×8-64 units, usually the encoder won't have seen that block before, and so compression won't be possible. Usually the encoder won't have seen that block before, because the number of possible Y mask blocks is 2\hat{ }64, which is about 1.8×10\hat{ }19, which is a large number. We have found that optimal size for a compression unit is a 2×4 part of a 8×8 Y mask. FIG. 30A shows an example of a 8×8 Y mask divided into eight 2×4 parts, suitable for compression. FIG. 30B is a diagram of 2×4 parts of a 8×8 Y mask, in which for each 2×4 part except the top left part, the arrows indicate which neighbouring 2×4 part(s) the 2×4 part uses to predict the values in the 2×4 part. For example, the 2×4 part below the top left 2×4 part uses the values in the top left 2×4 part for prediction. For example, the 2×4 top right part uses the values in the top left 2×4 part for prediction. Predictions are made using context.

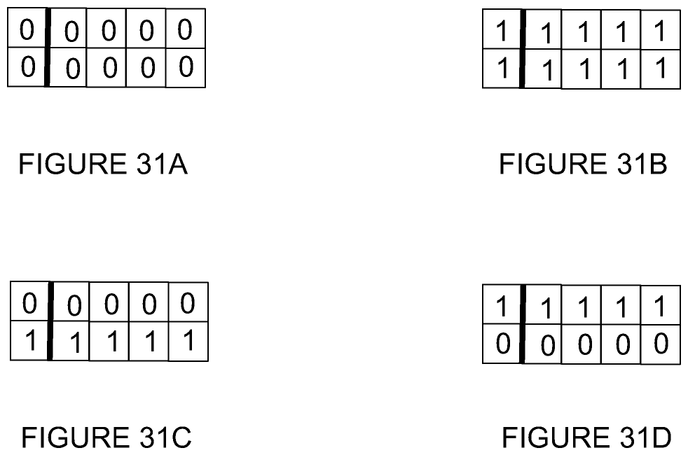

In an example, if the rightmost two places in the top left 2×4 part are zero and zero (e.g. e and d in FIG. 30B), then the top right 2×4 part may be predicted to be all zeros. An example is shown in FIG. 31A. In an example, if the rightmost two places in the top left 2×4 part are one and one (e.g. e and d in FIG. 30B), then the top right 2×4 part may be predicted to be all ones. An example is shown in FIG. 31B. In an example, if the rightmost two places in the top left 2×4 part are zero and one (e.g. e and d in FIG. 30B), then the top right 2×4 part may be predicted to be a row of zeros above a row of ones. An example is shown in FIG. 31C. In an example, if the rightmost two places in the top left 2×4 part are one and zero (e.g. e and d in FIG. 30B), then the top right 2×4 part may be predicted to be a row of ones above a row of zeros. An example is shown in FIG. 31D.

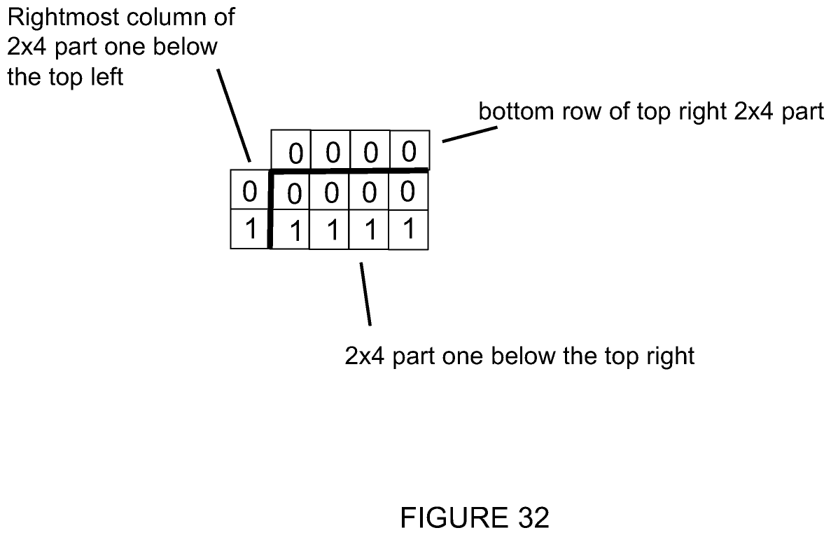

In an example, if the rightmost column in the 2×4 part one below the top left are zero and one, and the bottom row of the top right 2×4 part are all zeros, then the contents of the 2×4 part one below the top right may be predicted as shown in FIG. 32.

For the predictions, code words in the transition tables can be used. The most common arrangements of ones and zeros can receive the shortest code words, and the less common arrangements of ones and zeros can receive the longer code words, to aid in compression.

In general it is possible to convert from YUV values to RGB values, or from RGB values to YUV values, using lookup tables. RGB values may be used for the actual display step on a display. Therefore in some examples, two lookup table operations may be performed: for example a first lookup table operation for dithering YUV values, and a second lookup table operation to convert a dithered YUV value to a RGB value.

Interpolation between 8×8 pixel blocks in frames corresponding to different times may be used if a corresponding interpolation flag is set. Interpolation may be block type dependent. For example, if the block types are ones containing an edge, then the position of the edge may be interpolated between an earlier frame and a later frame. For example, if the block types are bilinear interpolation type, then linear interpolation may be performed between an 8×8 pixel block in an earlier frame and a corresponding 8×8 pixel block in a later frame. Typically in a video there are many instances when we can interpolate between the same type of block. Typically we cannot interpolate between 8×8 pixel blocks for different types of block, although an exception is interpolating between a uniform block and a bilinear interpolation block, because a uniform block may be considered to be a special case of a bilinear interpolation block.

So how do we decode the encoded data, e.g. for the case of a 8×8 pixel block including an edge? A pixel block has a known colour at each of its four corners, the known colours being C1, C2, C3 C4. We use a lookup table which is a function of the edge number (a number which particularizes where in the pixel block the line representing the edge starts and finishes). The lookup table is 128 Bits, which is two bits per pixel of the 8×8 pixel block, where 2×8×8=128. The two bits can take values 00, 01, 10 and 11, which correspond respectively to colours C1, C2, C3, C4. The lookup table tells you which corner colour value to use for that particular pixel in the pixel block. Dithering is used when rendering the pixels in the pixel block. Dither is an intentionally applied form of noise used to randomize quantization error, preventing artefacts in images. An example is shown in FIG. 10, in which not all the two bit dither values are shown. The lookup table is cached. In one or two clock cycles, you can get all the colours of all the pixels in a 8×8 block, using the lookup table. So this approach can achieve processing at 1 ns per pixel, and you can achieve processing of 64 million pixels per second, in javascript.

Using lookup tables is more computationally efficient than performing a full bilinear interpolation calculation for each 8×8 pixel block, because a lookup table is looked up, which is something a processor can do very quickly, whereas a full bilinear interpolation calculation for each pixel in an 8×8 pixel block may involve multiplication and division operations, which takes more computational time.

We can also have an 8×8 pixel block including a blurred edge, which has a different edge number to a corresponding 8×8 pixel block with a non-blurred edge, where the 8×8 pixel block including a blurred edge can have a lookup table corresponding to its edge number which is a blurred edge number. Here it takes no time to perform a blur calculation, because the blur is represented in a lookup table. A blurred edge may be referred to as a soft edge. A non-blurred edge may be referred to as a hard edge.

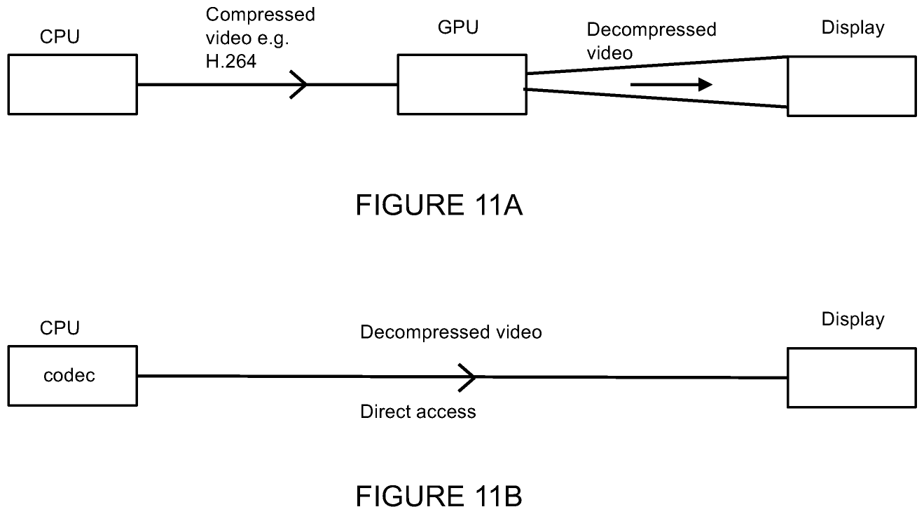

FIG. 11A shows a conventional approach to displaying video at a display, in which compressed video (e.g. H.264) is generated and sent from a central processing unit (CPU) and the compressed video is decompressed at a graphics processing unit (GPU) for display on a display.

In a lower energy approach to displaying decompressed video at a display, decompressed video is generated by a central processing unit (CPU) using a codec (e.g. the Blackbird 10 codec), and is sent for display on a display e.g. on a display that is 1080p, e.g. at 60 frames per second (fps). This is done without using a GPU. An example is shown in FIG. 11B. In our tests, a frame rate of 6 ms/frame has been achieved using our codec, which is better than 60 fps. In an example, on a smartphone, we have achieved 45 fps.

When an 8×8 pixel block is not suitable for representation in the compressed structure, shown for example in FIG. 4, for example because the image content is too complex for representation in the compressed structure, then these blocks are represented differently, such as in an overflow part of the data structure, after all those 8×8 pixel blocks which are suitable for representation in the compressed structure have been represented in the compressed structure.

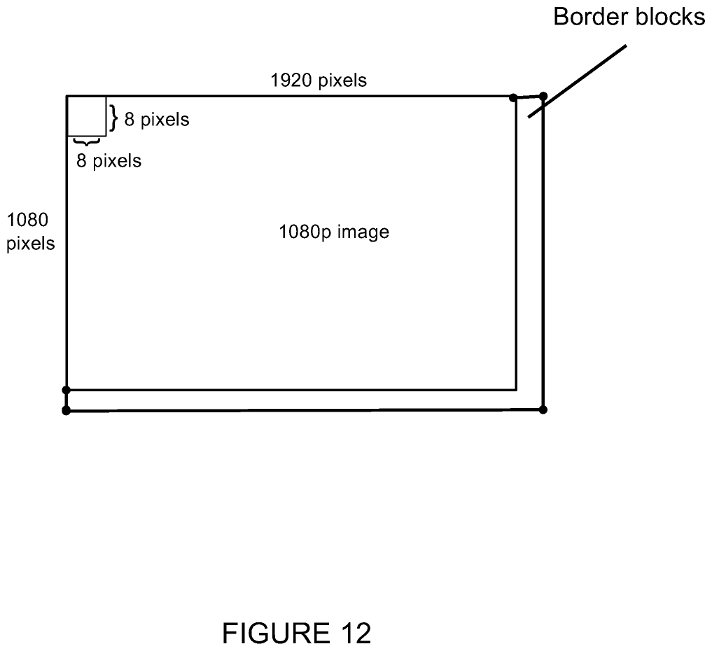

Some encoding of the 8×8 pixel blocks relies on information taken from blocks adjacent to a given 8×8 pixel block, e.g. colour values for the four corners of a 8×8 pixel block, where the values for three of the four corners are taken from adjacent 8×8 pixel blocks, e.g. as shown in FIG. 5. This can create a problem for a pixel block that is at an edge of an image, because it would have no adjacent pixel block along one or more sides of the pixel block. Hence in an example we include additional, border pixel blocks which are not part of an original image, so that any required information from an adjacent pixel block can be obtained from an additional, border pixel block, at an edge of the image, e.g. along two adjacent edges of the image. An example is shown in FIG. 12, in which additional, border pixel blocks are included at two adjacent edges of an image. The additional, border pixel blocks are not displayed.

For adjusting brightness, we can adjust the brightness using 8×8 pixel blocks. For YUV values, we only need to adjust the Y value to change the brightness, e.g. we can increase Y to increase the brightness. By using 8×8 pixel blocks, we can process 64 pixels at a time. This means that brightness can be processed 64 times faster than processing brightness on a per pixel basis. This could be performed for flag values of 0000, 0001, 0010 or 0011, i.e. for pixel blocks that are uniform, linearly interpolated, or which include an edge, or which include a line. This process may be performed in a video editor program.

For saturation, we can adjust U and V, similarly to how we adjust for brightness using Y. This process may be performed in a video editor program.

To create a mosaic effect, using 8×8 pixel blocks, in an example we set the flag to 0000, then each 8×8 pixel block is uniform. For example for a black and white mosaic, each 8×8 pixel block has its flag set to 0000, and alternate blocks are black or white. Other mosaics which are whole number multiples of 8×8 pixel blocks, e.g. 16×16 pixel blocks, may be created similarly. If we want a mosaic which does not align with (e.g. is not whole number multiples of) the 8×8 pixel blocks, then we may use two colour texturing.

Finding Edges. Finding Lines.

In encoding, in order to use an edge block to represent pixel data, first you have to find the edge. In encoding, in order to use a line block to represent pixel data, first you have to find the line.

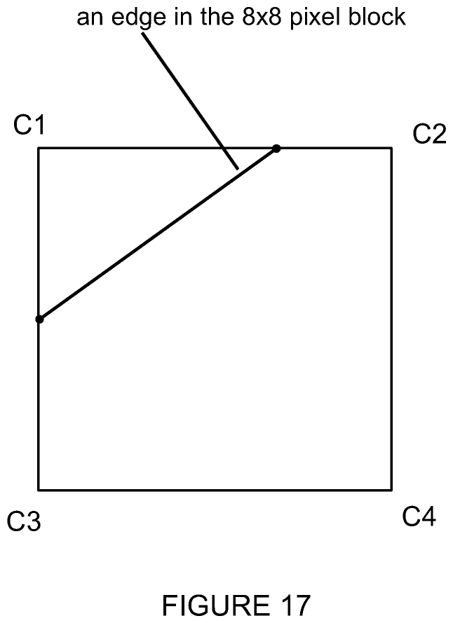

Consider an 8×8 original pixel block including an image of an edge, and with respective corner colours C1, C2, C3 and C4. An example is shown in FIG. 17.

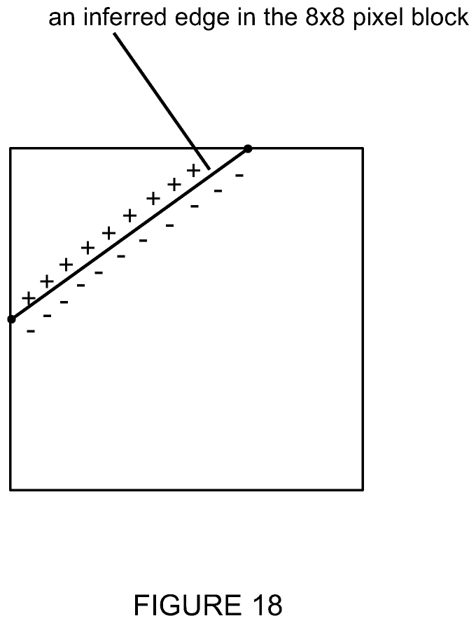

In an example method of finding an edge, in a first step we calculate an 8×8 pixel block in which the pixels are evaluated using bilinear interpolation based on the four corner colours C1, C2, C3 and C4. In a second step we compute an 8×8 difference pixel block that is the difference between the 8×8 original pixel block and the 8×8 pixel block in which the pixels are evaluated using bilinear interpolation based on the four corner colours C1, C2, C3 and C4. If the 8×8 original pixel block was one closely-matching bilinear interpolation based on the four corner colours, then this computed 8×8 difference pixel block will have entries which are zero, or entries which are close to zero. However, if the original pixel block included an image of an edge, then the 8×8 difference pixel block will have one area where the values are positive, and an adjacent area where the values are negative. The midpoints between where the values are positive, and where the values are negative, corresponds to the position of an inferred edge. An example of an 8×8 difference pixel block is shown in FIG. 18, in which the “+” signs indicate an area where the values are positive, and the “−” signs indicate an adjacent area where the values are negative, and the position of an inferred edge is indicated.

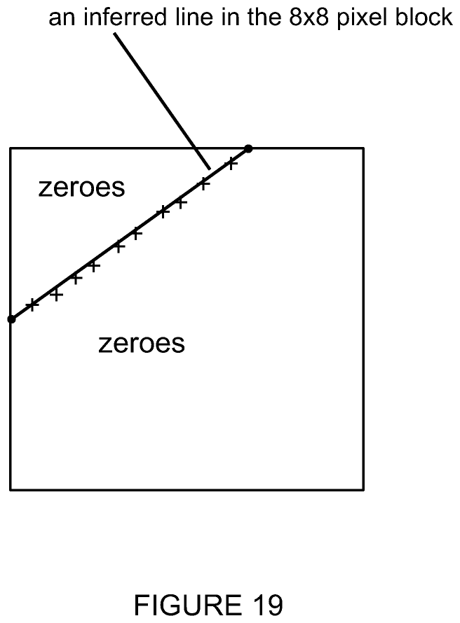

In an example method of finding a line, in a first step we calculate an 8×8 pixel block in which the pixels are evaluated using bilinear interpolation based on the four corner colours C1, C2, C3 and C4. In a second step we compute an 8×8 difference pixel block that is the difference between the 8×8 original pixel block and the 8×8 pixel block in which the pixels are evaluated using bilinear interpolation based on the four corner colours C1, C2, C3 and C4. If the 8×8 original pixel block was one closely-matching bilinear interpolation based on the four corner colours, then this computed 8×8 difference pixel block will have entries which are zero, or entries which are close to zero. However, if the original pixel block included an image of a line, then the 8×8 difference pixel block will have one line area where the values are all positive (or all negative, or nearly all positive, or nearly all negative), and an adjacent area where the values are zero, or close to zero. The line area where the values are all positive (or all negative, or nearly all positive, or nearly all negative) corresponds to the position of an inferred line. An example is shown in FIG. 19, in which the “+” signs indicate a line area where the values are positive, and the “zeroes” indicate adjacent areas where the values are zero, or close to zero, and the position of an inferred line is indicated.

When a line is encoded in the data structure, for a flag value of 0011, one bit in the data is used to indicate if the line is light or dark with respect to its surroundings. Further bits may be used to indicate the degree of lightness or darkness of the line with respect to its surroundings. A line is usually black, hence the default may be black.

### Motion Detection

It is acceptable for the compression process of a video file to be computationally slower than the playback of the video file, because the playback may be required to run in real-time, in javascript, in a browser, whereas compression is not faced with this possible requirement. For example, a compression process may be run on a fast machine, i.e. a machine with substantially greater processing capability than is available to a typical user, or real-time compression may not be required. Nevertheless, a fast compression is desirable e.g. to reduce the required computational resources, or to reduce the amount of energy required for the computation, which has environmental benefits.

Detecting motion between video frames is computationally demanding because we may have to compare an entire video frame with a next video frame. A frame is a two dimensional object, so the time taken to analyse a frame varies with the square of the number of pixels in each dimension of the frame. Comparing one frame with another requires the analysis of two frames with respect to each other, and hence this scales with the fourth power of the number of pixels in each dimension of the frame, which is an unfavourable power law relationship for analysing motion between video frames.

It turns out that it is effective to perform motion detection by analysing the edges in video frames, e.g. comparing the edges in a video frame with the edges in a next video frame. Perhaps typically only 1% of the 8×8 pixel blocks in an image are blocks with one or more edges. Hence we only need to compare about 1% of the blocks in a video frame with about 1% of the blocks in a next video frame, to perform motion detection on this basis. This can provide a 1/(1%*1%) or 10\hat{ }4 computational speed improvement factor over analysing all the blocks in a video frame and in a next video frame. This process is also 64×64 times faster than when analysing pixels, if 8×8 pixel blocks are used in the analysis. Hence the process of motion detection by analysing 8×8 pixel blocks of edges in the video frame and in a next video frame is about 40 million times faster than by analysing pixels alone.

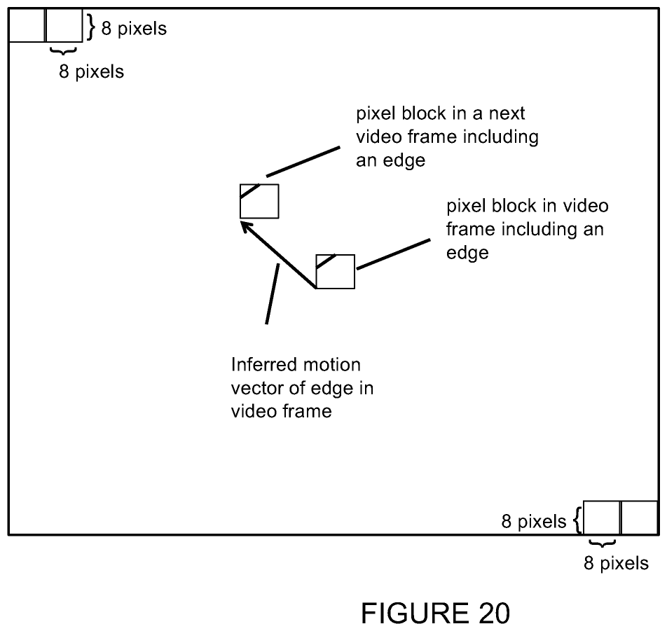

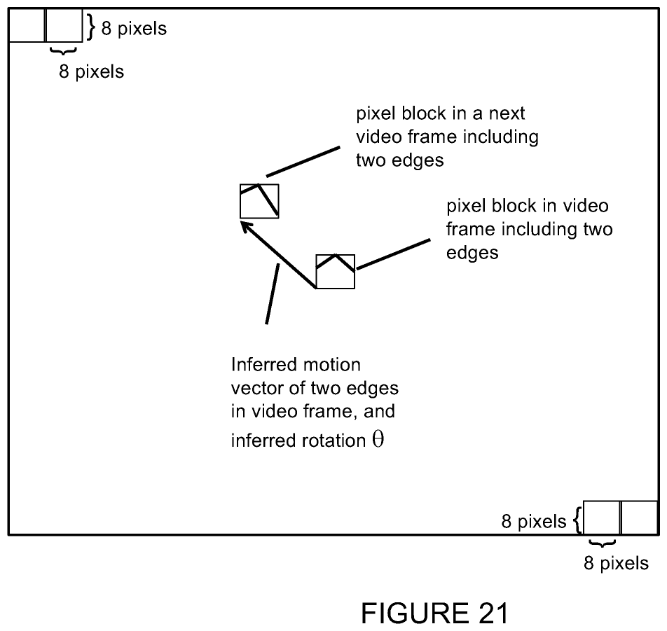

When analyzing 8×8 pixel blocks for motion detection, for a single edge, we only obtain information about the motion vector perpendicular to the edge, because motion parallel to the edge typically is not detected. An example is shown in FIG. 20. Pixel blocks containing two edges, such as a corner, are very helpful in motion detection analysis, because these can yield information about both orthogonal components of the motion vector, and any angle change, or rotation, θ. An example is shown in FIG. 21.

LUTs can be used for rotation detection. For example, there are about 1000 possible types of 8×8 pixel blocks containing a single edge. If we have 1000 possible types of 8×8 pixel blocks containing a single edge in the video frame, and 1000 possible types of 8×8 pixel blocks containing a single edge in a next video frame, this implies a possible 10\hat{ }3*10\hat{ }3=10\hat{ }6 possible edge pairs, when going from the video frame to the next video frame. A LUT is constructed such that providing an edge pair to the lookup table provides a two dimensional translation X, Y and an angle change θ of the edge, in return, where the pair is the edge type in the pixel block of the video frame, and the edge type in the pixel block of a next video frame. When analysing motion between video frames, usually θ is zero degrees, or close to zero degrees. In an example, if the detected angle change is greater in magnitude than a threshold value, this can be used to reject the candidate match between detected edges of a video frame, and of a next video frame. The returned X, Y and θ values are analysed to find consistent areas between the video frame, and a next video frame, to provide motion detection. Compression using a motion vector for each block would take up too much data. What we need is a motion vector for a group of blocks, or a consistent area, so that the number of motion vectors that are stored is greatly reduced, compared to the case of storing a motion vector for each block.

In videos, a lot of the motion that is detected is because the camera is moving, rather than for motion in the subject matter being viewed. Detecting a θ for the whole image can be interpreted as camera rotation, and this rotation can be removed, which is an example of a “steady camera” or “steadicam” function. Using our approach, this camera rotation removal can be performed using a lot less processing power than is used for current such functions.

### Note

Although here we have emphasized the use of 8×8 pixel blocks in video frame decompression and compression, the skilled person will understand that other sizes of pixel blocks could be used in video frame decompression and compression, such as 4×4 pixel blocks, or 16×16 pixel blocks.

In this disclosure, we have noted in several instances that a particular process can perform a computation quickly, or using relatively little processing power. Where this is the case, this also has an environmental benefit, because using relatively little processing power saves energy, which is environmentally beneficial.

### Improvements to Representations of Compressed Video

This section of this document relates to disclosures made in WO2005048607A1, U.S. Pat. No. 9,179,143B2 and U.S. Pat. No. 8,711,944B2.

There is provided a method of compressing digital data comprising the steps of(i) reading digital data as series of binary coded words representing a context and a codeword to be compressed, (ii) calculating distribution output data for the input data and assigning variable length codewords to the result; and (iii) periodically recalculating the codewords in accordance with a predetermined schedule, in order to continuously update the codewords and their lengths.

This disclosure relates to a method of processing of digital information such as video information. This digital video information may be either compressed for storage and then later transmission, or may be compressed and transmitted live with a small latency.

Transmission is for example over the internet.

There is a need for highly efficient compression techniques to be developed to enable transmission of video or other data in real time over the internet because of the restrictions in the bandwidth. In addition, the increasing need for high volume of content and rising end-user expectations mean that a market is developing for live compression at high frame rate and image size.

An object of this disclosure is to provide such compression techniques.

The video to be compressed can be considered as comprising a plurality of frames, each frame made up of individual picture elements, or pixels. Each pixel can be represented by three components, usually either RGB (red, green and blue) or YUV (luminance and two chrominance values). These components can be any number of bits each, but eight bits of each is usually considered sufficient.

The human eye is more sensitive to the location of edges in the Y values of pixels than the location of edges in U and V. For this reason, the preferred implementation here uses the YUV representation for pixels.

The image size can vary, with more pixels giving higher resolution and higher quality, but at the cost of higher data rate. Where the source video is in PAL format, the image fields have 288 lines with 25 frames per second. Square pixels give a source image size of 384×288 pixels. The preferred implementation has a resolution of 376×280 pixels using the central pixels of a 384×288 pixel image, in order to remove edge pixels which are prone to noise and which are not normally displayed on a TV set.

The images available to the computer generally contain noise so that the values of the image components fluctuate. These source images may be filtered as the first stage of the compression process. The filtering reduces the data rate and improves the image quality of the compressed video.

A further stage analyses the contents of the video frame-by-frame and determines which of a number of possible types pixel should be allocated to. These broadly correspond to pixels in high contrast areas and pixels in low contrast areas.

The pixels are hard to compress individually, but there are high correlations between each pixel and its near neighbours. To aid compression, the image is split into one of a number of different types of components. The simpler parts of the image split into rectangular components, called “super-blocks” in this application, which can be thought of as single entities with their own structure. These blocks can be any size, but in the preferred implementation described below, the super-blocks are all the same size and are 8×8 pixel squares. More structurally complex parts of the image where the connection between pixels further apart is less obvious are split up into smaller rectangular components, called “mini-blocks” in this application.

It is apparent that if each super-block is compressed separately, the errors resulting from the compression process can combine across edges between super-blocks thus illustrating the block-like nature of the compression by highlighting edges between blocks, which is undesirable. To avoid this problem, the mini-blocks are tokenised with an accurate representation and these are compressed in a loss free way.

Each super-block or mini-block is encoded as containing YUV information of its constituent pixels.

This U and V information is stored at lower spatial resolution than the Y information, in one implementation with only one value of each of U and V for every mini-block. The super-blocks are split into regions. The colour of each one of these regions is represented by one UV pair.

### Real Time Motion Estimation

The video frames are filtered into “Noah regions”. Thus the pixels near to edges are all labelled. In a typical scene, only between 2% and 20% of the pixels in the image turn out to have the edge labelling. There are three types of motion estimation used. In the first, whole frame pan detection using integer number of pixels is implemented.

These motions can be implemented efficiently over the whole image on playback as pixels can be copied to new locations and no blurring is needed. This uses the edge areas from the Noah regions only, as the edges contain the information needed for an accurate motion search. The second is sub-pixel motion removal over the whole image.

This uses the edge areas from the Noah regions only, as the edges contain the information needed for an accurate motion search. The edge pixels in the image, estimated by example from the Noah filtering stage, are matched with copies of themselves with translations of up to e.g. 2 pixels, but accurate to e.g. 1/64 pixel (using a blurring function to smooth the error function) and small rotations. The best match is calculated by a directed search starting at a large scale and increasing the resolution until the required sub-pixel accuracy is attained. This transformation is then applied in reverse to the new image frame and filtering continues as before. These changes are typically ignored on playback. The effect is to remove artefacts caused by camera shake, significantly reducing data rate and giving an increase in image quality. The third type examines local areas of the image. Where a significant proportion of the pixels are updated, for example on an 8×8 pixel block, either motion vectors are tested in this area with patches for the now smaller temporal deltas, or a simplified super-block representation is used giving either 1 or 2 YUVs per block, and patches are made to this.

### Real Time Fade Representation

The encoding is principally achieved by representing the differences between consecutive compressed frames. In some cases, the changes in brightness are spatially correlated. In this case, the image is split into blocks or regions, and codewords are used to specify a change over the entire region, with differences with these new values rather than differences to the previous frame itself being used.

### Segment Noah Regions-Find Edges

A typical image includes areas with low contrast and areas of high contrast, or edges. The segmentation stage described here analyses the image and decides whether any pixel is near an edge or not. It does this by looking at the variance in a small area containing the pixel. For speed, in the current implementation, this involves looking at a 3×3 square of pixels with the current pixel at the centre, although implementations on faster machines can look at a larger area. The pixels which are not near edges are compressed using an efficient but simple representation which includes multiple pixels-for example 2×2 blocks or 8×8 blocks, which are interpolated on playback. The remaining pixels near edges are represented as either e. g., 8×8 blocks with a number of YUV areas (typically 2 or 3) if the edge is simply the boundary between two or more large regions which just happen to meet here, or as 2×2 blocks with 1 Y and one UV per block in the case that the above simple model does not apply e.g. when there is too much detail in the area because the objects in this area are too small.

### Miniblockify

The image is made up of regions, which are created from the Noah regions. The relatively smooth areas are represented by spatially relatively sparse YUV values, with the more detailed regions such as the Noah edges being represented by 2×2 blocks which are either uniform YUV, or include a UV for the block and maximum Y and a minimum Y, with a codeword to specify which of the pixels in the block should be the maximum Y value and which should be the minimum. To further reduce the datarate, the Y pairs in the non-uniform blocks are restricted to a subset of all possible Y pairs which is more sparse when the Y values are far apart.

Transitions with Variable Lengths Codewords

Compressing video includes in part predicting what the next frame will be, as accurately as possible from the available data, or context. Then the (small) unpredictable element is what is sent in the bitstream, and this is combined with the prediction to give the result. The transition methods described here are designed to facilitate this process. On compression, the available context and codeword to compress are passed to the system. This then adds this information to its current distribution (which it is found performs well when it starts with no prejudice as the likely relationship between the context and the output codeword). The distribution output data for this context is calculated and variable length codewords assigned to the outcomes which have arisen. These variable length codewords are not calculated each time the system is queried as the cost/reward ratio makes it unviable, particularly as the codewords have to be recalculated on the player at the corresponding times they are calculated on the compressor. Instead, the codewords are recalculated from time to time. For example, every new frame, or every time the number of codewords has doubled. Recalculation every time an output word is entered for the first time is too costly in many cases, but this is aided by not using all the codeword space every time the codewords are recalculated. Codeword space at the long end is left available, and when new codewords are needed then next one is taken. As these codewords have never occurred up to this point, they are assumed to be rare, and so giving them long codewords is not a significant hindrance. When the codeword space is all used up, the codewords are recalculated. The minimum datarate for Huffman codewords is a very flat and wide minimum, so using the distribution from the codewords which have occurred so far is a good approximation to the optimal. Recalculating the codewords has to happen quickly in a real time system. The codewords are kept sorted in order of frequency, with the most frequent codewords first. In an example, the sorting is a mixture of bin sort using linked lists which is O (n) for the rare codewords which change order quite a lot, and bubble sort for the common codewords which by their nature do not change order by very much each time a new codeword is added. The codewords are calculated by keeping a record of the unused codeword space, and the proportion of the total remaining codewords the next data to encode takes. The shorted codeword when the new codeword does not exceed its correct proportion of the available codeword space is used. There are further constraints: in order to keep the codes as prefix codes and to allow spare space for new codewords, codewords never get shorter in length, and each codeword takes up an integer power of two of the total codeword space. This method creates the new codewords into a lookup table for quick encoding in O(n) where n is the number of sorted codewords.

Give Compressed Codeword for this Uncompressed Codeword

Every time a codeword occurs in a transition for the second or subsequent time, its frequency is updated and it is re-sorted. When it occurs for the first time in this transition however, it must be defined. As many codewords occur multiple times in different transitions, the destination value is encoded as a variable length codeword each time it is used for the first time, and this variable length codeword is what is sent in the bitstream, preceded by a “new local codeword” header codeword. Similarly, when it occurs for the first time ever, it is encoded raw preceded by a “new global codeword” header codeword. These header codewords themselves are variable length and recalculated regularly, so they start off short as most codewords are new when a new environment is encountered, and they gradually lengthen as the transitions and concepts being encoded have been encountered before.

### Video Compression (Cuts)

Cuts are compressed using spatial context from the same frame.

Cuts, RLE uniform shape, else assume independent and context=CUT_CW.

Cuts->editable, so needs efficient. First approximation at lower resolution e. g., 8×8.

Cuts-predict difference in mini-block codewords from previous one and uniform flag for current one.

### Video Compression (Deltas)

The deltas can use temporal and spatial context.

Deltas shape-predict shape from uniformness of four neighbours and old shape. Deltas-predict mini-block codeword differences from uniformness of this miniblock and old mini-block in time.

### Multi-Level Gap Masks: 4×4, 16×16, 64×64

The bulk of the images are represented mbs and gaps between them. The gaps are spatially and temporally correlated. The spatial correlation is catered for by dividing the image into 4×4 blocks of mbs, representing 64 pixels each, with one bit per mini-block representing whether the mbs has changed on this frame. These 4×4 blocks are grouped into 4×4 blocks of these, with a set bit if any of the mbs it represents have changed. Similarly, these are grouped into 4×4 blocks, representing 128×128 pixels, which a set bit if any of the pixels has changed in the compressed representation. It turns out that trying to predict 16 bits at a time is too ambitious as the system does not have time to learn the correct distributions in a video of typical length. Predicting the masks 4×2 pixels at a time works well. The context for this is the corresponding gap masks from the two previous frames. The transition infrastructure above then gives efficient codewords for the gaps at various scales.

### Multiple Datarates at Once

One of the features of internet or intranet video distribution is that the audience can have a wide range of receiving and decoding equipment. In particular the connection speed may vary widely. In a system such as this designed for transmission across the internet, it helps to support multiple datarates. So the compression filters the image once, then resamples it to the appropriate sizes involving for example cropping so that averaging pixels to make the final image the correct size involves averaging pixels in rectangular blocks of fixed size. There is a sophisticated datarate targeting system which skips frames independently for each output bitstream. The compression is sufficiently fast on a typical modern PC of this time to create modem or midband videos with multiple target datarates. The video is split into files for easy access, and these files may typically be 10 seconds long, and may start with a key frame. The player can detect whether its pre-load is ahead or behind target and load the next chunk at either lower or higher datarate to make use of the available bandwidth. This is particularly important if the serving is from a limited system where multiple simultaneous viewers may wish to access the video at the same time, so the limit to transmission speed is caused by the server rather than the receiver. The small files will cache well on a typical internet setup, reducing server load if viewers are watching the video from the same ISP, office, or even the same computer at different times.

### Key Frames

The video may be split into a number of files to allow easy access to parts of the video which are not the beginning. In these cases, the files may start with a key frame. A key frame contains all information required to start decompressing the bitstream from this point, including a cut-style video frame and information about the status of the Transition Tables, such as starting with completely blank tables.

### Digital Rights Management (DRM)

DRM is an increasingly important component of a video solution, particularly now content is so readily accessible of the internet. Data typically included in DRM may be an expiry data for the video, a restricted set of URLs the video can be played from. Once the compressor itself is sold, the same video may be compressed twice with different DRM data in an attempt to crack the DRM by looking at the difference between the two files. The compression described here is designed to allow small changes to the initial state of the transition or global compression tables to effectively randomise the bitstream. By randomizing a few bits each time a video is compressed, the entire bitstream is randomized each time the video is compressed, making it much harder to detect differences in compressed data caused by changes to the information encoded in DRM.

### Miscellaneous

The Y values for each pixel within a single super-block can also be approximated.

In many cases, there is only one or part of one object in a super-block. In these cases, a single Y value is often sufficient to approximate the entire super-block's pixel Y values, particularly when the context of neighbouring super-blocks is used to help reconstruct the image on decompression.

In many further cases, there are only two or parts of two objects in a super-block.

In these cases, a pair of Y values is often sufficient to approximate the entire superblock's Y values, particularly when the context of the neighbouring super-blocks is used to help reconstruct the image on decompression. In the cases where there are two Y values, a mask is used to show which of the two Y values is to be used for each pixel when reconstructing the original super-block. These masks can be compressed in a variety of ways, depending on their content, as it turns out that the distribution of masks is very skewed. In addition, masks often change by small amounts between frames, allowing the differences between masks on different frames to be compressed efficiently.

Improvements to image quality can be obtained by allowing masks with more than two Y values, although this increases the amount of information needed to specify which Y value to use.

Although this disclosure has been given with particular reference to video data, it will be appreciated that it could also be applied to other types of data such as audio data.

### EXAMPLES

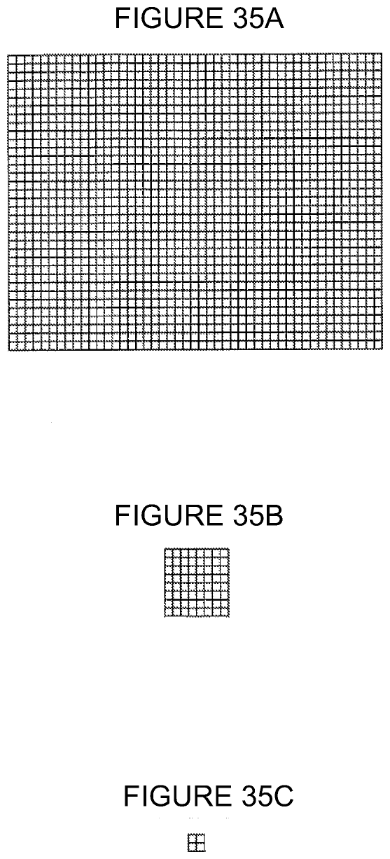

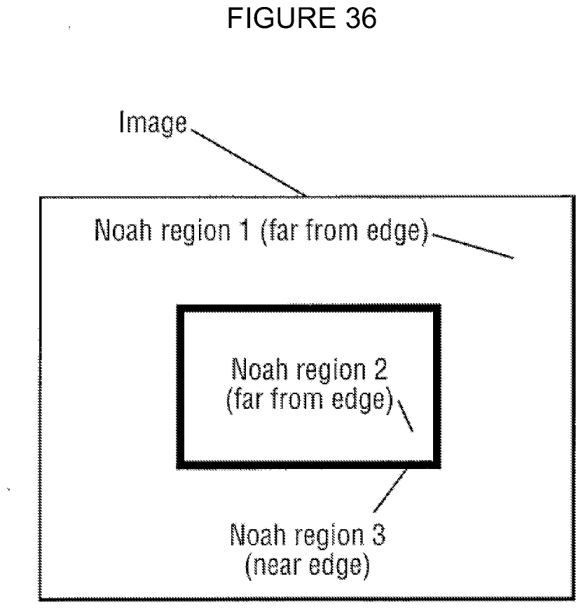

Video frames of typically 384×288, 376×280, 320×240, 192×144, 160×120 or 128×96 pixels (see e.g. FIG. 35A) are divided into pixel blocks, typically 8×8 pixels in size (see e.g. FIG. 35B), and also into pixel blocks, typically 2×2 pixels in size, called mini-blocks (see e.g. FIG. 35C). In addition, the video frames are divided into Noah regions (see e.g. FIG. 36), indicating how complex an area of the image is.

In one implementation, each super-block is divided into regions, each region in each super-block approximating the corresponding pixels in the original image and containing the following information:
1 Y values (typically 8 bits)
1 U value (typically 8 bits)
1 V value (typically 8 bits)
64 bits of mask specifying which YUV value to use when reconstructing this super-block.

In this implementation, each mini-block contains the following information:
2 Y values (typically 8 bits each)
1 U value (typically 8 bits)
1 V value (typically 8 bits)
4 bits of mask specifying which Y value to use when reconstructing this mini-block.

### Temporal Gaps

If more latency is acceptable, temporal gaps rather than spatial gaps turn out to be an efficient representation. This involves coding each changed mini-block with a codeword indicating the next time (if any) in which it changes.

### Interpolation Between Uniform Super-Blocks

Where uniform super-blocks neighbour each other, bilinear interpolation between the Y, U and V values used to represent each block is used to find the Y, U and V values to use for each pixel on playback.

In an example, there is provided a method of processing digital video information for transmission or storage after compression, said method comprising: reading digital data representing individual picture elements (pixels) of a video frame as a series of binary coded words; segmenting the image into regions of locally relatively similar pixels and locally relatively distinct pixels; having a mechanism for learning how contextual information relates to codewords requiring compression and encoding such codewords in a way which is efficient both computationally and in terms of compression rate of the encoded codewords and which dynamically varies to adjust as the relationship between the context and the codewords requiring compression changes and which is computationally efficient to decompress; establishing a reduced number of possible luminance values for each block of pixels (typically no more than four); encoding to derive from the words representing individual pixels further words describing blocks or groups of pixels each described as a single derived word which at least includes a representation of the luminance of a block component of at least eight by eight individual pixels (super-block); establishing a reduced number of possible luminance values for each block of pixels (typically no more than four); encoding to derive from the words representing individual pixels further words describing blocks or groups of pixels each described as a single derived word which at least includes a representation of the luminance of a block component of typically two by two individual pixels (mini-block); establishing a reduced number of possible luminance values for each block of pixels (typically one or two); providing a series of changeable stored masks as a mechanism for indicating which of the possible luminance values are to be used in determining the appropriate luminance value of each pixel for display; comparing and evaluating the words representing corresponding portions of one frame with another frame or frames in a predetermined sequential order of the elements making up the groups to detect differences and hence changes; identifying any of the masks which require updating to reflect such differences and choosing a fresh mask as the most appropriate to represent such differences and storing the fresh mask or masks for transmission or storage; using context which will be available at the time of decompression to encode the masks, the changes in Y values, U values, and V values, and the spatial or temporal gaps between changed blocks, combined with the efficient encoding scheme, to give an efficient compressed real time representation of the video; using variable length codewords to represent the result of transitions in a way which is nearly optimal from a compression point of view, and computational very efficient to calculate.

There is provided a method of compressing digital data comprising the steps of: (i) reading digital data as series of binary coded words representing a context and a codeword to be compressed; (ii) calculating distribution output data for the input data and assigning variable length codewords to the result; and (iii) periodically recalculating the codewords in accordance with a predetermined schedule, in order to continuously update the codewords and their lengths.

The method may be one in which the codewords are recalculated each time the number of codewords has doubled. The method may be one in which the codewords are recalculated for every new frame of data. The method may be one in which some codeword space is reserved at each recalculation so as to allow successive new codewords to be assigned for data of lower frequency.

There is provided a method of processing digital video information so as to compress it for transmission or storage, said method comprising: reading digital data representing individual picture elements (pixels) of a video frame as a series of binary coded words; segmenting the image into regions of locally relatively similar pixels and locally relatively distinct pixels; establishing a reduced number of possible luminance values for each block of pixels (typically no more than four); carrying out an encoding process so as to derive from the words representing individual pixels, further words describing blocks or groups of pixels each described as a single derived word which at least includes a representation of the luminance of a block component of at least eight by eight individual pixels (super-block); establishing a reduced number of possible luminance values for each smaller block of pixels (typically no more than four); carrying out an encoding process so as to derive from the words representing individual pixels, further words describing blocks or groups of pixels each described as a single derived word which at least includes a representation of the luminance of a block component of typically two by two individual pixels (mini-block); establishing a reduced number of possible luminance values for each block of pixels (typically one or two); providing a series of changeable stored masks to indicate which of the possible luminance values are to be used in determining the appropriate luminance value of each pixel for display; comparing and evaluating the words representing corresponding portions of one frame with another frame or frames in a predetermined sequential order of the elements making up the groups to detect differences and hence changes; identifying any of the masks which require updating to reflect such differences and choosing a fresh mask as the most appropriate to represent such differences and storing the fresh mask or mask for transmission or storage; using context which will be available the time of decompression to encode the masks, the changes in Y values (luminance), U values (chrominance), and V values (chrominance) and the spatial or temporal gaps between changed blocks, combined with the efficient encoding scheme, to give an efficient compressed real time representation of the video; and using variable length codewords to represent the result of transitions.

The method may be one in which the method further comprises an adaptive learning process for deriving a relationship between contextual information and codewords requiring compression, and a process for dynamically adjusting the relationship so as to optimise the compression rate and the efficiency of decompression.

There is provided a method of compressing digital data for storage or transmission, comprising the steps of:
(i) reading inputted digital data as series of binary coded words representing a context and an input codeword to be compressed;
(ii) calculating distribution output data for the inputted digital data and generating variable length prefix codewords for each combination of context and input codeword, and generating a respective sorted Transition Table of variable length prefix codewords for each context, in a manner in which codeword space at the long end is left available to represent new input codewords, which have not yet occurred with corresponding contexts, as they occur; and
(iii) repeating the process of step (ii) from time to time;
(iv) whereby the inputted digital data can be subsequently replayed by recalculating the sorted Transition Table of local codewords at corresponding times in the inputted digital data.

The method may be one in which the codewords are recalculated for every new frame of data. The method may be one in which some codeword space is reserved at each recalculation so as to allow successive new codewords to be assigned for data of lower frequency. The method may be one in which some codeword space is reserved at each recalculation so as to allow successive new codewords to be assigned for data of lower frequency.

There is provided a method of compressing digital data for storage or transmission, comprising the steps of:
(i) reading digital data as a series of binary coded words representing a context and a codeword to be compressed;
(ii) calculating distribution output data for the input data and generating variable length prefix codewords for each combination of context and input codeword so as to form a respective sorted Transition Table of local codewords for each context, in a manner which reserves logical codeword space at the long end to represent any new input codewords, which have not yet occurred with that context, as they occur for the first time; and
(iii) repeating the process of step (ii) from time to time;
(iv) whereby the input data can be subsequently replayed by recalculating the codeword tables at corresponding times in the input data, wherein the codewords are recalculated each time the number of codewords has doubled.

There is provided a method of compressing digital data for storage or transmission, comprising the steps of:
(i) reading digital data as a series of binary coded words representing a context and a codeword to be compressed;
(ii) calculating distribution output data for the input data and generating variable length prefix codewords for each combination of context and input codeword so as to form a respective sorted Transition Table of local codewords for each context, in a manner which reserves logical codeword space at the long end to represent any new input codewords, which have not yet occurred with that context, as they occur for the first time; and
(iii) repeating the process of step (ii) from time to time;
(iv) whereby the input data can be subsequently replayed by recalculating the codeword tables at corresponding times in the input data, wherein the method further comprises an adaptive learning process for deriving a relationship between contextual information and codewords requiring compression, and a process for dynamically adjusting the relationship so as to optimize the compression rate and the efficiency of decompression.

### A Method of Compressing Video Data and a Media Player for Implementing the Method

This section of this document relates to disclosures made in WO2007077447A2 and U.S. Pat. No. 8,660,181B2

There is provided a method of receiving video data comprising the steps of: receiving at least one chunk of video data comprising a number of sequential key video frames where the number is at least two and, constructing at least one delta frame between a nearest preceding key frame and a nearest subsequent key frame from data contained in the either or each of the nearest preceding and subsequent frames.

Visual recordings of moving things are generally made up of sequences of successive images. Each such image represents a scene at a different time or range of times. This disclosure relates to such sequences of images such as are found, for example, in video, film and animation.

Video takes a large amount of memory, even when compressed. The result is that video is generally stored remotely from the main memory of the computer. In traditional video editing systems, this would be on hard discs or removable disc storage, which are generally fast enough to access the video at full quality and frame rate. Some people would like to access and edit video files content remotely, over the internet, in real time. This disclosure relates to the applications of video editing (important as much video content on the web will have been edited to some extent), video streaming, and video on demand.

At present any media player editor implementing a method of transferring video data across the internet in real time suffers the technical problems that: (a) the internet connection speed available to internet users is, from moment to moment, variable and unpredictable; and (b) that the central processing unit (CPU) speed available to internet users is from moment to moment variable and unpredictable.

For the application of video editing, consistent image quality is very preferable, because many editing decisions are based on aspects of the image, for example, whether the image was taken in focus or out.

It is an object of the present disclosure to alleviate at least some of the aforementioned technical problems. Accordingly this disclosure provides a method of receiving video data comprising the steps of: receiving at least one chunk of video data comprising a number (n) of sequential key video frames where the number (n) is at least two and, constructing at least one delta frame between a nearest preceding key frame and a nearest subsequent key frame from data contained in either, or each, of the nearest preceding and subsequent frames.

Preferably the delta frame is composed of a plurality of component blocks or pixels and each component of the delta frame is constructed according to data indicating it is one of: the same as the corresponding component in the nearest preceding key frame, or the same as the corresponding component in the nearest subsequent key frame, or a new value compressed using some or all of the spatial compression of the delta frame and information from the nearest preceding and subsequent frames. After the step of construction, the delta frame may be treated as a key frame for the construction of one or more further delta frames. Delta frames may continue to be constructed in a chunk until either: a sufficiently good predetermined image playback quality criterion is met or the time constraints of playing the video in real time require the frames to be displayed. The number of key frames in a chunk may be in the range from n=3 to n=10.

Although the method may have other applications, it is particularly advantageous when the video data is downloaded across the internet. In such a case it is convenient to download each key frame in a separate download slot, the number of said download slots equating to the maximum number of download slots supportable by the internet connection at any moment in time. Preferably each slot is implemented in a separate thread. Where it is desired to subsequently edit the video it is preferable that each frame, particularly the key frames, are cached upon first viewing to enable subsequent video editing.

According to another aspect of this disclosure, there is provided a media player arranged to implement the method which preferably comprises a receiver to receive chunks of video data including at least two key frames, and a processor adapted to construct a delta frame sequentially between a nearest preceding key frame and a nearest subsequent key frame. Preferably, a memory is also provided for caching frames as they are first viewed to reduce the subsequent requirements for downloading.

According to a third aspect of this disclosure, there is provided a method of compressing video data so that the video can be streamed across a limited bandwidth connection with no loss of quality on displayed frames which entails storing video frames at various temporal resolutions which can be accessed in a pre-defined order, stopping at any point. Thus multiple simultaneous internet accesses can ensure a fairly stable frame rate over a connection by (within the resolution of the multitasking nature of the machine) simultaneously loading the first or subsequent temporal resolution groups of frames from each of a number of non-intersecting subsets of consecutive video frames until either all the frames in the group are downloaded, or there would probably not be time to download the group, in which case a new group is started.

This disclosure includes a method for enabling accurate editing decisions to be made over a wide range of internet connection speeds, as well as video playback which uses available bandwidth efficiently to give a better experience to users with higher bandwidth. Traditional systems have a constant frame rate, but the present disclosure relates to improving quality by adding extra delta frame data, where bandwidth allows.

A source which contains images making up a video, film, animation or other moving picture is available for the delivery of video over the internet. Images (2, 4, 6 . . . ) in the source are digitised and labelled with frame numbers (starting from zero) where later times correspond to bigger frame numbers and consecutive frames have consecutive frame numbers. The video also has audio content, which is split into sections.

The video frames are split into chunks as follows: A value of n is chosen to be a small integer 0≥n. In one implementation, n is chosen to be 5. A chunk is a set of consecutive frames of length 2\hat{ }n. All frames appear in at least one chunk, and the end of each chunk is always followed immediately by the beginning of another chunk.

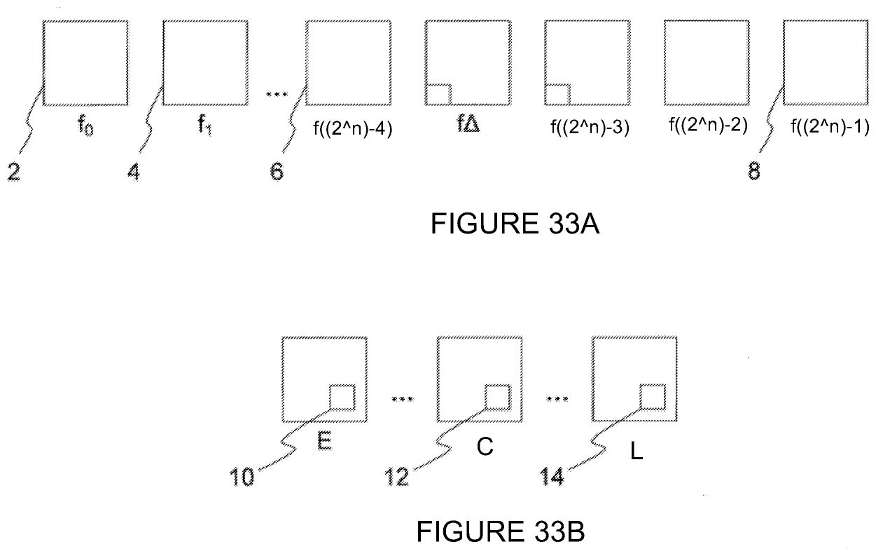

“f” represent the frame number in the chunk, where the earliest frame (2) in each chunk has f=0, and the last (8) has f=(2\hat{ }n)−1 (see e.g. FIG. 33A).

All f=0 frames in a chunk are compressed as key frames—that is they can be recreated without using data from any other frames. All frames equidistant in time between previously compressed frames are compressed as delta frames recursively as follows:

Let frame C (see e.g. FIG. 33B) be the delta frame being compressed. Then there is a nearest key frame earlier than this frame, and a nearest key frame later than this frame, which have already been compressed. Let us call them E and L respectively. Each frame is converted into a spatially compressed representation, in one implementation comprising rectangular blocks of various sizes with four Y or UV values representing the four corner values of each block in the luminance and chrominance respectively.

Frame C is compressed as a delta frame using information from frames E and L (which are known to the decompressor), as well as information as it becomes available about frame C.

In one implementation, the delta frame is reconstructed as follows:

Each component (12) of the image (pixel or block) is represented as either: the same as the corresponding component (10) in frame E; or the same as the corresponding component (14) in frame L; or a new value compressed using some or all of spatial compression of frame C, and information from frames E and L.

Compressing the video data in this way allows the second part of the disclosure to function. This is described next. When transferring data across the internet, using the HTTP protocol used by web browsers, the described compression has advantages, for example enabling access through many firewalls. The two significant factors relevant to this disclosure are latency and bandwidth. The latency here is the time taken between asking for the data and it starting to arrive. The bandwidth here is the speed at which data arrives once it has started arriving. For a typical domestic broadband connection, the latency can be expected to be between 20 ms and Is, and the bandwidth can be expected to be between 256 kb/s and 8 Mb/s.

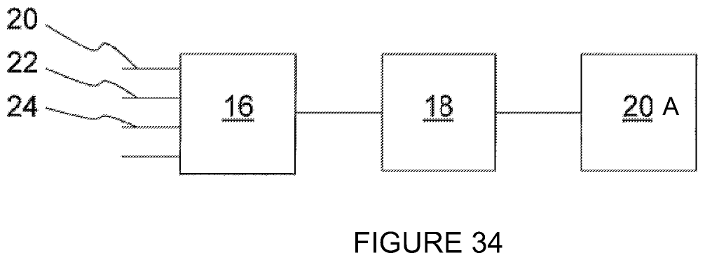

The disclosure involves one compression step for all supported bandwidths of connection, so the player (e.g. 16, FIG. 34) has to determine the data to request which gives the best playback experience. This may be done as follows:

The player has a number of download slots (20, 22, 24 . . . ) for performing overlapping downloads, each running effectively simultaneously with the others. At any time, any of these may be blocked by waiting for the latency or by lost packets. Each download slot is used to download a key frame, and then subsequent files (if there is time) at each successive granularity. When all files pertaining to a particular section are downloaded, or when there would not be time to download a section before it is needed for decompression by the processor (18), the download slot is applied to the next unaccounted for key frame.

In one implementation of the disclosure, each slot is implemented in a separate thread.

A fast link results in all frames being downloaded, but slower links download a variable frame rate at e.g. 1, ½, ¼, ⅛ etc of the frame rate of the original source video for each chunk. This way the video can play back with in real time at full quality, possibly with some sections of the video at lower frame rate.

In a further implementation, as used for video editing, frames downloaded in this way are cached in a memory (20A) when they are first seen, so that on subsequent accesses, only the finer granularity videos need be downloaded.

The number of slots depends on the latency and the bandwidth and the size of each file, but is chosen to be the smallest number which ensures the internet connection is fully busy substantially all of the time.

In one implementation, when choosing what order to download or access the data in, the audio is given highest priority (with earlier audio having priority over later audio), then the key frames, and then the delta frames (within each chunk) in the order required for decompression with the earliest first.

There is provided a method of receiving video data comprising the steps of: receiving at least one chunk of video data comprising a number (n) of sequential key video frames where the number (n) is at least two and, constructing at least one delta frame (C) between a nearest preceding key frame (E) and a nearest subsequent key frame (L) from data contained in the either or each of the nearest preceding and subsequent frames.

The method may be one wherein the delta frame (C) is composed of a plurality of component blocks or pixels and each component of the delta frame is constructed according to data indicating it is one of:
(a) the same as the corresponding component in the nearest preceding key frame (E), or
(b) the same as the corresponding component in the nearest subsequent key frame (L), or (c) a new value compressed using some or all of the spatial compression of frame C, and information from the nearest preceding and subsequent frames.

The method may be one wherein after the step of construction, the delta frame is treated as a key frame for the construction of one or more delta frames.

The method may be one wherein delta frames continue to be constructed in a chunk until either: a sufficiently good predetermined image playback quality criterion is met or the time constraints of playing the video in real time require the frames to be displayed.

The method may be one wherein the number of key frames is in the range from n=3 to n=10.

The method may be one comprising downloading the video data across the internet.

The method may be one comprising downloading each key frame in a separate download slot, the number of said download slots equating to the maximum number of download slots supportable by the internet connection at any moment in time.

The method may be one wherein each slot is implemented in a separate thread.

The method may be one wherein each frame is cached upon first viewing to enable subsequent video editing.

The method may be one wherein the key frames are cached.

There is provided a media player configured to implement the method according to any one of the above statements.

The media player may be one having: a receiver to receive chunks of video data including at least two key frames, a processor adapted to construct a delta frame sequentially between a nearest preceding key frame and a nearest subsequent key frame.

There is provided a method of compressing video data so that the video can be streamed across a limited bandwidth connection with no loss of quality on displayed frames, the method comprising storing video frames at various temporal resolutions which can be accessed in a pre-defined order, stopping at any point.

The method may be one where multiple simultaneous internet accesses can ensure a fairly stable frame rate over a connection by simultaneously loading the first or subsequent temporal resolution groups of frames from each of a number of non-intersecting subsets of consecutive video frames until either all the frames in the group are downloaded, or until a predetermined time has elapsed, and then in starting a new group.

There is provided a method of compressing video data with no loss of frame image quality on the displayed frames, by varying the frame rate relative to the original source video, the method comprising the steps of:
receiving at least two chunks of uncompressed video data, each chunk comprising at least two sequential video frames and,
compressing at least one frame in each chunk as a key frame, for reconstruction without the need for data from any other frames,
compressing at least one intermediate frame as a delta frame between a nearest preceding key frame and a nearest subsequent key frame from data contained in either or each of the nearest preceding and subsequent frames,
wherein further intermediate frames are compressed as further delta frames within the same chunk, by treating any previously compressed delta frame as a key frame for constructing said further delta frames, and
storing the compressed video frames at various mutually exclusive temporal resolutions, which are accessed in a pre-defined order, in use, starting with key frames, and followed by each successive granularity of delta frames, stopping at any point; and
whereby the frame rate is progressively increased as more intermediate data is accessed.

The method may be one wherein the delta frame is composed of a plurality of component blocks or pixels and each component of the delta frame is constructed according to data indicating it is one of:
(a) the same as the corresponding component in the nearest preceding key frame, or
(b) the same as the corresponding component in the nearest subsequent key frame, or
(c) a new value compressed using some or all of the spatial compression of frame, and information from the nearest preceding and subsequent frames.

The method may be one wherein after the step of construction, the delta frame is treated as a key frame for the construction of one or more delta frames.

The method may be one wherein delta frames continue to be constructed in a chunk until either: a predetermined image playback quality criterion, including a frame rate required by an end-user, is met or the time constraints of playing the video in real time require the frame to be displayed.

The method may be one wherein the number of frames in a chunk is 2\hat{ }n, and n is in the range from n=3 to n=10.

The method may be one comprising downloading the video data across the internet.

The method may be one comprising downloading each key frame in a separate download slot, the number of said download slots equating to the minimum number to fully utilize the internet connection.

The method may be one wherein each slot is implemented in a separate thread.

The method may be one wherein each frame is cached upon first viewing to enable subsequent video editing.

The method may be one wherein the key frames are cached.

There is provided a method of processing video data comprising the steps of:
receiving at least one chunk of video data comprising 2\hat{ }n frames and one key video frame, and the next key video frame;
constructing a delta frame (C) equidistant between a nearest preceding key frame (E) and a nearest subsequent key frame (L) from data that includes data contained in either or each of the nearest preceding and subsequent key frames;
constructing additional delta frames equidistant between a nearest preceding key frame and a nearest subsequent key frame from data that includes data contained in either or each of the nearest preceding and subsequent key frames, wherein at least one of the nearest preceding key frame or the nearest subsequent key frame is any previously constructed delta frame; storing the additional delta frames at various mutually exclusive temporal resolutions, which are accessible in a pre-defined order, in use, starting with the key frames, and followed by each successive granularity of delta frames, stopping at any point; and continuing to construct the additional delta frames in a chunk until either a predetermined image playback quality criterion, including a user selected frame rate, is achieved, or a time constraint associated with playing of the chunk of video data in real time requires the frames to be displayed.

The method may be one further comprising downloading the at least one chunk of video data at a frame rate that is less than an original frame rate associated with the received video data.

The method may be one further comprising determining a speed associated with the receipt of the at least one image chunk, and only displaying a plurality of constructed frames in accordance with the time constraint and the determined speed.

### Further Disclosures

EP3329678B1 discloses a method of encoding a series of frames in a video or media, including receiving a first key frame, receiving subsequent chunks of frames including at least one key frame, dividing each frame into a plurality of blocks, subdividing a first block of the plurality of blocks into a plurality of pixel groups, averaging the pixels in each pixel group to generate a single value, creating a first mini-block wherein each element of said first mini block corresponds with a pixel group of the corresponding first block and contains said single value, repeating for each block of each frame of the chunk, comparing a first of said plurality of mini blocks of a first frame with mini blocks of a second frame, where said second frame mini blocks are not necessarily aligned to mini blocks in the first frame, until a best match is achieved.

U.S. Pat. No. 11,082,699B2 discloses a method for encoding and decoding a video stream comprising dividing the video stream into a first Key frame, and subsequent chunks each comprising 2ⁿ frames, each chunk including a Key frame and 2⁻¹ Delta (DN) frames, where x is a positive integer and denotes the level of the Delta frame, and where 2^{x-1} denotes the number of Delta frames at that level in the chunk; the method including the step of constructing D^{x} level frames from adjacent Earlier and Later D^{y} frames, (where y<x and where for y=0, D^{y} is a Key frame), for all frames in a chunk where x>0; wherein the constructing step includes: dividing the frame into Motion Regions representing groups of pixels; determining a pixel group in an Earlier (E: D^{y}) and later (L: D^{y}) frame that is a best match for a pixel group in a Motion Region of a Current (C: D^{y}) frame; determining motion vectors for the best matches for Motion Regions, or by intra-frame compression of frame C. The method is characterised by eliminating unnecessary information when building a bitstream such that as x increases, motion vector and other data relating to a combination of D^{x} frames (more numerous than the D^{x-1} frames) is represented by a quantity of data in the bitstream that, for a typical video, increases at a much lower rate than the quantity of frames in D^{x} compared to the quantity of frames in D^{x-1}.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method of encoding a colour video, the colour video comprising colour video frames, the colour video frames including 1920 pixels by 1080 pixels, the method including the step of:
(i) encoding colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits, wherein the codeword comprise 64 bits including a codeword type, the representation including zero or more extension codewords depending on the codeword type specified.

2. The method of claim 1, wherein encoding the video includes lossy encoding.

3. The method of claim 1, wherein encoding the video does not use a Fourier transform.

4. The method of claim 1, wherein in the codeword colour is represented using at least ten bits each for YUV.

5. The method of claim 1, wherein in the codeword colour is represented using at least ten bits each for RGB.

6-7. (canceled)

8. The method of claim 1, wherein the codeword includes 64 bits, comprising a flag including at least 4 bits, data bits e.g. 30 bits of data, and 30 bits to represent ten bits each for the Y value, the U value and the V value, or ten bits each for the R value, the G value and the B value.

9. The method of claim 1, wherein the codeword consists of exactly 64 bits.

10. The method of claim 8, wherein one or more bits in the (e.g. 30) data bits is used as an extension pointer, which points to extension block(s) which include extra data, for use with specific flag values, in which the specific flag values correspond to encoded 8×8 pixel blocks including image data that is too complex to represent accurately in a standard 64 bit codeword.

11-12. (canceled)

13. The method of claim 1, wherein a codeword unique flag value corresponds to a uniform block, with a colour given by 30 bits that represent colour.

14. The method of claim 13, in which the data part of the uniform block codeword is all zeros, or all ones, because there is no data.

15. The method of any previous claim 1, wherein a codeword unique flag value corresponds to a bilinear interpolation, in which four colour values are used to perform a bilinear interpolation, the four colour values including one colour for each corner, in which one colour value for one corner is represented in the codeword, and the other three colours are obtained from the codewords for blocks neighbouring the other three corners.

16. The method of claim 15, in which the data part of the bilinearly interpolated block codeword is all zeros, or all ones, because there is no data.

17. The method of claim 15, in which the bilinear interpolation is performed moving in a direction by adding a first constant value, and the bilinear interpolation is performed moving orthogonal to the direction by adding a second constant value.

18. The method of claim 15, in which a bilinearly interpolated encoded 8×8 pixel block is defined using dithering.

19. The method of any previous claim 1, wherein a codeword unique flag value corresponds to an encoded 8×8 pixel block including a single edge, the single edge position defined by 9 or 10 bits in the data bits.

20. The method of any previous claim 1, wherein for each pixel, a dither value is stored using three bits.

21. The method of any previous claim 1, wherein to determine the colour at a corner of a 8×8 pixel block, in a region where there are no abrupt changes in colour, e.g. there are no edges, the colour is determined by averaging the colours in an (e.g. 8×8) pixel area centred on the corner.

22. The method of any previous claim 1, wherein to determine the colour at a corner of a pixel block, for part of an edge-containing image of an 8×8 pixel block, the part containing only one corner, the selected colour is chosen by averaging pixels including using some pixels in neighbouring 8×8 pixel blocks.

23. The method of claim 22, in which to make the averaging unbiased, an area of pixels outside the 8×8 pixel block is excluded from the averaging process which is symmetric, relative to the one corner, with the area of pixels in the 8×8 pixel block which is on the opposite side of the edge to the one corner.

24. The method of any previous claim 1, wherein to evaluate a corner colour when an edge passes directly through the corner, the colour C1 for the corner through which the edge passes is evaluated using the colours of the other three corners C2, C3 and C4 though which the edge does not pass, e.g. by averaging C2, C3 and C4, or by using bilinear extrapolation of the colours C2, C3, C4.

25. The method of claim 1, wherein in the case of a 8×8 pixel block including an edge and a corner on one side of the edge, a block corner colour is selected for the corner using only use pixel colours which are on the same side of the edge as the corner.

26. The method of claim 1, wherein an edge type identifier is stored for a 8×8 pixel block in which an edge passes directly through a corner.

27. The method of claim 1, in which the edge types do not exceed 512, and hence are represented using 9 bits.

28-133. (canceled)

134. A computer program product executable on a processor to encode a colour video, the colour video comprising colour video frames, the colour video frames including 1920 pixels by 1080 pixels, the computer program product executable on the processor to:
(i) encode colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits, wherein the codeword comprises 64 bits including a codeword type, the representation including zero or more extension codewords depending on the codeword type specified.

135. (canceled)

136. A device configured to encode a colour video, the colour video comprising colour video frames, the colour video frames including 1920 pixels by 1080 pixels, the device configured to encode the colour video by encoding colour video frames using a 240 elements by 135 elements representation of the 1920 pixels by 1080 pixels, each element comprising an encoded 8×8 pixel block, wherein each encoded 8×8 pixel block is represented using a representation including a codeword, the codeword including 64 bits, wherein the codeword comprises 64 bits including a codeword type, the representation including zero or more extension codewords depending on the codeword type specified.

137. The device of claim 136, wherein the device is configured to capture a video stream and to encode the colour video using the video stream.

138-288. (canceled)
